(19) United States
(12) Patent Application Publication
(10) Pub. No.: US 2025/0351008 A1
(43) Pub. Date: Nov. 13, 2025

(54) MANAGING QUALITY OF SERVICE AND COORDINATING BETWEEN USERS LOCATED IN DIFFERENT NETWORK REGIONS AND INTERACTING IN THE SAME VIRTUAL ENVIRONMENT OF A MULTI-USER APPLICATION

(71) Applicant: HUAWEI TECHNOLOGIES CO., LTD., Shenzhen (CN)

(72) Inventors: Clarissa Marquezan, Munich (DE); Riccardo Trivisonno, Munich (DE); Qing Wei, Munich (DE)

(73) Assignee: HUAWEI TECHNOLOGIES CO., LTD., Shenzhen (CN)

(21) Appl. No.: 19/220,133

(22) Filed: May 28, 2025

Related U.S. Application Data
(63) Continuation of application No. PCT/EP2023/056595, filed on Mar. 15, 2023.

(51) Int. Cl. H04W 28/24; H04L 41/0894; H04L 41/5019; H04L 47/10

(52) U.S. Cl. CPC H04W 28/24; H04L 41/0894; H04L 41/5019; H04L 47/10

(57) ABSTRACT

The present disclosure relates to extended reality (XR) applications and services. The disclosure is concerned with managing quality of service (QoS) of flows of a multi-user (XR) application, wherein multiple users of the application are located in different networks or network regions or different groups of control plane entities. A multi-user QoS policy that defines information to be used for the management of two or more flows of the multi-user application is established. The multi-user QoS policy is employed by a control plane entity for managing QoS of a first set of one or more flows of the multi-user application, or a session management entity for supporting the management of QoS of at least one flow two or more flows of a multi-user application. Further, the disclosure also provides corresponding methods and computer programs.

### CROSS-REFERENCE TO RELATED APPLICATIONS

This application is a continuation of International Application No. PCT/EP2023/056595, filed on Mar. 15, 2023, the disclosure of which is hereby incorporated by reference in its entirety.

### TECHNICAL FIELD

The present disclosure relates to multi-user applications and services, for example, to extended reality (XR) applications. The disclosure is concerned with managing a quality of service (QOS) of one or more flows of such a multi-user application, in particular, for multiple users located in different networks or network regions. The disclosure provides a first control plane entity for managing QoS of a first set of one or more flows of a multi-user application. The disclosure also provides a first session management entity for supporting the management of QoS of at least one flow of two or more flows of a multi-user application. Further, the disclosure also provides corresponding methods and computer programs.

### BACKGROUND

The 3^{rd} generation partnership project (3GPP) release SAI TR 22.856 R19 defines use cases of Metaverse applications, which constitute a type of application that demand high reliability, very low latency and high bandwidth. In mobile networks, these type of applications are associated with Real Time Broadband Communication (RTBC) type of traffic.

Metaverse applications, such as collaborative and concurrent engineering in product design; or immersive gaming consists of users that are virtual interacting simultaneously with each other in the same Virtual Environment (VE) of the given Metaverse application (for example, XR Application in this disclosure or the multi-user application in this disclosure). When such kind of applications are used in mobile networks, it also means that users of the same VE might belong to different Public Land Mobile Networks (PLMNs). These means that it is possible that for the same

VE of an XR application (e.g., a multi-user application), different users are served by different mobile operators (e.g., different mobile operators provider the serving communication services to the different users of the multi-applications).

The XR traffic of users of the same XR application server in the same VE have to be handled symmetrically in the multiple PLMNs (or by multiple control planes of different network groups or network regions) to provide a stable Quality of Experience (QoE) for the users. In a 5^{th} generation system (5GS), there exists the possibility of having interactions among PLMNs in order to handle the traffic of users in roaming. A user equipment (UE) in roaming means that a UE with a contract with one operator (Home PLMN (HPLMN) #1) is being physically served (i.e., has access network and core network services) in a visiting PLMN infrastructure (Visiting PLMN (VPLMN) #2). In this case, HPLMN and VPLMN network functions (NFs)—like Policy Control Function (PCF) and Session Management Function (SMF) are able to exchange information that influences the traffic treatment of the UE in the visiting PLMN. However, in case of Metaverse applications, the users participating and interacting in the same VE are not in roaming. Therefore, new mechanisms need to be defined in order to enable the coordination and alignment of QoS fulfillment of the UEs over the multiple PLMNs.

### SUMMARY

The present disclosure and its solutions are based further on the following considerations made by the inventors.

There are two groups of solutions related to the issue of coordinating the QoS policies applied to the UEs served by multiple PLMNs that are interacting in the same VE of an XR application. The first is related to the support for interactions among multiple PLMNs in a 3GPP 5G system. The second is related to specific solutions for the coordination of the QoS policies applied to Packet Data Unit (PDU) sessions of XR applications defined in the 3GPP TR 23.700-60.

On the first group of solutions the following solutions are discussed.
The 3GPP TS 23.501 specification defines the concept of roaming related to NFs from multiple PLMNs in 5G systems being able to interact to handle the traffic of the users. There are two types of roaming: Roaming with Local Break, defined in 3GPP TS 23.501 Clause 5.6.3: where the SMF and all User Plane Function (UPFs) involved in managing the PDU Session of the UE in roaming are under control of the VPLMN. Home Routed (HR) Roaming, defined in 3GPP TS 23.501 Clause 5.6.3: where the PDU Session of the UE in roaming is supported by a SMF function under control of the HPLMN, and by a SMF function under the control of the VPLMN, by at least one UPF under control of the HPLMN and by at least one UPF under control of the VPLMN. In this case the SMF in HPLMN selects the UPF(s) in the HPLMN and the SMF in VPLMN selects the UPF(s) in the VPLMN. The policies applied to the HR roaming PDU session are defined by the PCF at the HPLMN.
Another solution is provided for Inter-PLMN handover of UEs among Equivalent PLMNs (EPLLMNs). In this case, the UE is able to use in the same physical location different EPLMNs.

On the second group the following aspects have been discussed and proposed in TR 23.700-60.
General conclusions: (a) XR service support is defined for a single PLMN and define the support for multiple PCFs serving multiple UEs that are related to the same XR application, while not supporting policy coordination among PCFs of the same PLMN. (b) The Application Function (AF) session with required QoS parameters procedure (defined in 3GPP TS 23.502) will be used for XR AF to inform the network about the XR QoS parameters for multiple UEs in multi-modality XR applications.
Specific solutions from TR 23.700-60 related to coordination of QoS among PCFs within the single PLMN: Solution #2 (Clause 6.2) proposes the prioritization of possible QoS Parameters alternatives to enable all PCFs to operate with the same Group Policy parameters. Solution #4 (Clause 6.4) proposes that PCFs subscribe to each other to receive notification of changes each other enforce in the group of QoS Flows and can adjust/synchronize their parameters once each PCF had finalized the process of updating their own version of the group QoS policy (i.e., at the end of any PDU Session Modification procedure). Solution #37 proposes that PCC Rules for group QoS of XR UEs will be only changed by AF session request. No mention is done for the cases that RAN cannot support the previously agreed QoS requirements and PCF needs to update itself the PCC rules. Solution #67 proposes an “all-or-nothing” approach when QoS fulfilment of the group of QoS Flows from UEs is not achieved, then the solution releases all the PDU sessions of all the UEs interacting in the same VE of the XR application.

The above solutions, however, have the following disadvantages:
Current triggers for coordination of QoS policies to be applied to UE traffic in multiple PLMNs (i.e., VPLMN and HPLMN) do not apply for XR applications, because the Users (with different mobile operators) of the same VE are not in Roaming as per 5GS definition.
In the proposed solutions in TR 23.700-61, there is a high delay when executing the procedures for coordinating the QoS parameters among the multiple PCFs.
AF using the procedures for setting up and modifying the AF session with required QoS parameters in the multiple PLMNs will lead to a high delay on aligning the QoS requirements and maintaining the fulfillment of such requirement among the PLMNs.

In view of the above, this disclosure has the objective to provide a solution that overcomes these disadvantages. An objective is, for example, to avoid that users in one network or network region or PLMN with a bad QoS fulfilment drag the entire VE to a bad performance. Another objective is, for example, to avoid that an AF attempts to equalize QoS parameters by itself using the updates in AF session QoS requirements in each individual network region, as this lead to delays on equalizing process. Another objective is to avoid the risk of disconnecting users or creating cyber-sickness for some users in the VE due to delays.

These and other objectives are achieved by the solutions of this disclosure as described in the independent claims. Advantageous implementations are further described in the dependent claims.

A first aspect of this disclosure provides a first control plane entity for managing QoS of a first set of one or more flows of a multi-user application, wherein the first control plane entity is in a first network and/or in a first network region, or is in a first group of control plane entities of a network, and wherein the first control plane entity is configured to: obtain binding information that indicates a multi-user group identification (ID), which is related to two or more flows of the multi-user application; wherein at least one of the two or more flows is in the first set of flows managed by the first control plane entity, and at least one of the two or more flows is in a second set of flows managed by a second control plane entity; wherein the second control plane entity is in a second network and/or in a second network region, or is in a second group of control plane entities of the network; establish a multi-user QoS policy that defines first information to be used for the management of the two or more flows of the multi-user application, which are related to the multi-user group ID; wherein the multi-user QoS policy is associated with the multi-user group ID and/or a multi-user policy ID.

By defining the multi-user policy for flows in different networks or network regions, for instance, different PLMNs, the disadvantages of the solutions described above can be overcome. In particular, QoS of the multi-user application can be managed better across different networks or network regions. Delays may be avoided, and a bad QoS fulfilment in one network or network region does not drag down the QoS fulfilment in another network or network region.

In an implementation form of the first aspect, the binding information includes at least one of the following: the multi-user group ID; flow related information; application related information; QoS requirement(s) related information; information identifying one or more control plane entities associated with the multi-user group ID; information for accessing the one or more control plane entities associated with the multi-user group ID; a mapping of one or more flows to one or more control plane entities associated with the multi-user group ID; information related to boundaries of QoS requirements to be used by the one or more control plane entities associated with the multi-user group ID.

In an implementation form of the first aspect, the first information defined by the multi-user QoS policy determines one or more parameters and/or associated values related to one or more of the following: one or more control plane entities associated with the multi-user QoS policy; one or more interaction actions among two or more control plane entities associated with the multi-user QoS policy; a mapping of one or more flows to a control plane entity associated with the multi-user QoS policy; one or more QoS requirements associated with the one or more flows; information to reach or to enable the interaction with each of the one or more control plane entities associated with the multi-user QoS policy; application related information.

In an implementation form of the first aspect, the first control plane entity is configured to receive the binding information from an AF and/or from the second control plane entity, and/or from a third control plane entity.

In an implementation form of the first aspect, the first control plane entity is configured to: establish the multi-user QoS policy based on the binding information and/or based on multi-user QoS policy configuration information; wherein the multi-user QoS policy configuration comprises at least one of: one or more acceptable ranges of deviation for one or more QoS requirements; one or more acceptable ranges of deviation for one or more alternative QOS requirements; a QoS degradation threshold for triggering a session release, the session comprising one or more flows; a session retry back off timer; an enforcement strategy for the multi-user QoS policy; a policy distribution strategy for the multi-user QoS policy.

In an implementation form of the first aspect, the first control plane entity is further configured to determine based on the binding information, whether the first control plane entity is a coordinator control plane entity among at least two control plane entities associated with the same multi-user group ID and/or multi-user policy ID.

In an implementation form of the first aspect, the first control plane is configured to determine whether the first control plane entity is the coordinator control plane entity based on: the binding information and one or more parameters of a service level agreement (SLA), where the one or more parameters are received from another control plane entity associated with the multi-user group ID and/or multi-user policy ID; or the binding information and one or more parameters of a SLA, where the one or more parameters are configured at the first control plane entity associated with the multi-user group ID and/or multi-user policy ID; the binding information and a coordination indication received from an AF related to the multi-user group ID.

In an implementation form of the first aspect, the first control plane entity is further configured to send, to the second control plane entity, second information that comprises a request to the second control plane entity, to confirm by the second control plane entity that the second control plane entity has also established a multi-user QoS policy associated with the multi-user group ID and/or the multi-user policy ID.

In an implementation form of the first aspect, the second information includes information related to the multi-user QoS policy to be used at the second control plane entity.

In an implementation form of the first aspect, the first control plane entity is further configured to, upon receiving a confirmation that the second control plane entity has also established a multi-user QoS policy associated with the multi-user group ID and/or the multi-user policy ID, associate an ID of the second control plane entity with the multi-user QoS policy established at the first control plane entity.

In an implementation form of the first aspect, the first control plane entity is further configured to send, to the second control plane entity, third information that indicates to the second control plane entity that the first control plane entity has established the multi-user QoS policy associated with the multi-user group ID and/or the multi-user policy ID.

In an implementation form of the first aspect, the first control plane entity sends the second information, if it determines that the first control plane entity is the coordinator control plane entity; or the first control plane entity sends the third information, if it does not determine that the first control plane entity is the coordinator control plane entity

In an implementation form of the first aspect, the multi-user QoS policy comprises: a local policy including one or more parameters related to the multi-user QoS policy for a single control plane entity for managing QoS, such as the first control plane entity; and/or a global policy including one or more parameters related to the multi-user QoS policy for any control plane entity for managing QoS and associated with the same multi-user group ID and/or multi-user policy ID.

In an implementation form of the first aspect, the first control plane entity is further configured to provide a support message to a first session management entity, wherein the first session management entity is in the first network and/or the first network region or associated with the first group of control plane entities of the network; wherein the first session management entity is related to the at least one flow in the first set of flows managed by the first control plane entity, and wherein the support message includes one or more of: an ID of the first control plane entity; an ID of the second control plane entity; an indication that the second control plane entity is in a different network and/or network region or group of control plane entities of a network than the first session management entity; an address or reference or identification of the second control plane entity, wherein the address or reference or identification indicates to the first session management entity that it can obtain session management and/or QoS control information from the second control plane entity for at least one flow in the first set of flows managed by the first control plane entity; the multi-user group ID and/or the multi-user policy ID; one or more flow IDs of flows of the multi-user application.

In an implementation form of the first aspect, the first control plane entity is further configured to receive a QoS control information from a second session management entity, which is in the second network and/or in the second network region, or is associated with the second group of control plane entities of the network; wherein the QoS control information indicates a QoS problem of the at least one flow in the second set of flows managed by the second control plane entity.

In an implementation form of the first aspect, the first control plane entity is further configured to provide, to the first session management entity and/or to the second session management entity, a freezing indication that is related to the QoS problem indicated by the QoS control information received from the first session management entity and/or from the second session management entity.

In an implementation form of the first aspect, the first control plane entity is further configured to: receive a first freezing notification from the second session management entity, the first freezing notification indicating that all one or more flows of a session related to the second set of flows or a single flow of a session including multiple flows of the second set of flows related to the multi-user application associated with the multi-user group ID and/or the multi-user policy ID has been frozen; and/or receive a second freezing notification from the first session management entity, the second freezing notification indicating that a single flow of a session including multiple flows of the first set of flows of the multi-user application associated with the multi-user group ID and/or the multi-user policy ID has been frozen.

In an implementation form of the first aspect, the first control plane entity is further configured to send the received first and/or second freezing notification to an AF related to the multi-user group ID associated with the multi-user application.

In an implementation form of the first aspect, the information defined by the multi-user QoS policy comprises at least one of the following: one or more parameters determining one or more interactions executed by at least the first and the second control plane entities managing the two or more flows related to the multi-user group ID and/or the multi-user QoS Policy ID; one or more parameters and/or associated values related to the QoS requirements of the two or more flows of the multi-user application related to the multi-user group ID and/or the multi-user QoS Policy ID; one or more parameters and/or associated values related to the information defining each of the flows related to the multi-user group ID and/or the multi-user QoS Policy ID; one or more parameters and/or associated values defining a mapping between one or more flows and one or more control plane entities both related to the multi-user group ID and/or the multi-user policy ID; one or more parameters and/or associated values defining a mapping among an identification of a control plane entity related to the multi-user group ID and/or the multi-user policy ID to an address and/or reference point of said control plane entity, and/or an identification of the network, and/or an identification of the network region; and/or an identification of the group of control plane entities of the network; one or more parameters and/or associated values defining the application related information, for example, an application identification and/or an address or reference point of the associated AF to the application.

A second aspect of this disclosure provides a first session management entity for supporting the management of QoS of at least one flow of the two or more flows of a multi-user application, wherein the first session management entity is in a first network and/or in a first network region, or is associated with a first group of control plane entities of a network, wherein the two or more flows of the multi-user application are related to a multi-user group ID and/or a multi-user policy ID associated with a multi-user QoS policy, and wherein the first session management entity is configured to: receive a support message from a first control plane entity, wherein the support message includes one or more of: an ID of the first control plane entity, wherein the first control plane entity is in the first network and/or in the first network region or in the first group of control plane entities, and wherein the at least one flow of the two or more flows of the multi-user application is in a first set of flows managed by the first control plane entity; an ID of a second control plane entity, wherein the second control plane entity is in a second network and/or in a second network region, or is in a second group of control plane entities of the network, and wherein at least one further flow of the two or more flows is in a second set of flows managed by the second control plane entity; an indication that the second control plane entity is in a different network and/or network region than the first session management entity; an address or reference or identification of the second control plane entity, wherein the address or reference or identification indicates to the first session management entity that it can obtain session management and/or QoS management control information from the second control plane entity for the at least one flow of the two or more flows of the multi-user application related to the multi-user group ID and/or the multi-user policy ID; the multi-user group ID and/or the multi-user policy ID; one or more flow IDs of flows of the multi-user application.

In an implementation form of the second aspect, the first session management entity is further configured to determine a multi-user QoS fulfilment status of the multi-user QoS policy related to the at least one flow of the two or more flows related to the multi-user group ID and/or the multi-user policy ID, wherein the QoS fulfilment status indicates whether one or more QoS requirements of the QoS policy are or are not fulfilled.

In an implementation form of the second aspect, the first session management entity is further configured to: determine the multi-user QoS fulfillment status based on support information related to the multi-user group ID and/or multi-user policy ID received from a second control plane entity; wherein the second control plane entity is in the second network and/or second network region, or is associated with the second group of control plane entities.

In an implementation form of the second aspect, the first session management entity is further configured to send support information related to the multi-user group ID and/or multi-user policy ID to one or more other session management entities.

In an implementation form of the second aspect, the first session management entity is further configured to provide a QoS control information to the first control plane entity and/or to the second control plane entity; wherein the QoS control information indicates a QoS problem of at least one of the two or more flows of the multi-user application; and herein the QoS problem is based on an insufficient QoS fulfillment status of the multi-user QoS policy associated with the multi-user group ID and/or multi-user policy ID.

In an implementation form of the second aspect, the first session management entity is further configured to determine, based on the support information, to which of the first control plane entity and/or the second control plane entity to provide the QoS control information.

In an implementation form of the second aspect, the first session management entity is further configured to receive, from the first control plane entity and/or from the second control plane entity, a freezing indication that is related to a QoS problem indicated by the QoS control information.

In an implementation form of the second aspect, the first session management entity is further configured to: provide a first freezing notification to the second control plane entity, the first freezing notification indicating that all one or more flows of a session related to the first set of flows of the multi-user application associated with the multi-user group ID and/or the multi-user policy ID or a single flow of a session including multiple flows related to the first set of flows of the multi-user application associated with the multi-user group ID and/or the multi-user policy ID has been frozen; and/or provide a second freezing notification to the first control plane entity, the second freezing notification indicating that a single flow of a session including multiple flows of the first set of flows related to the multi-user application associated with the multi-user group ID and/or the multi-user policy ID has been frozen.

A third aspect of this disclosure provides a method for managing QoS of a first set of one or more flows of a multi-user application, wherein the method is performed by a first control plane entity that is in a first network and/or in a first network region, or is in a first group of control plane entities of a network, and wherein the method comprises: obtaining binding information that indicates a multi-user group identification, ID, which is related to two or more flows of the multi-user application; wherein at least one of the two or more flows is in the first set of flows managed by the first control plane entity, and at least one of the two or more flows is in a second set of flows managed by a second control plane entity; wherein the second control plane entity is in a second network and/or in a second network region, or is in a second group of control plane entities of the network; establishing a multi-user QoS policy that defines first information to be used for the management of the two or more flows of the multi-user application, which are related to the multi-user group ID; wherein the multi-user QoS policy is associated with the multi-user group ID and/or a multi-user policy ID.

The method of the third aspect may have implementation forms that correspond to the implementation forms of the first network entity of the first aspect. The method of the third aspect and its implementation forms achieve the same advantages as described for the first network entity of the first aspect and its respective implementation forms.

A fourth aspect of this disclosure provides a method for supporting the management of QoS of at least one flow of two or more flows of a multi-user application, wherein the method is performed by a first session management entity that is in a first network and/or in a first network region, or is associated with a first group of control plane entities of a network, wherein the two or more flows of the multi-user application are related to a multi-user group ID and/or a multi-user policy ID associated with a multi-user QoS policy, and wherein the method comprises: receiving a support message from a first control plane entity, wherein the support message includes one or more of: an ID of the first control plane entity, wherein the first control plane entity is in the first network and/or in the first network region or in the first group of control plane entities, and wherein the at least one flow of the two or more flows of the multi-user application is in a first set of flows managed by the first control plane entity; an ID of a second control plane entity, wherein the second control plane entity is in a second network and/or in a second network region, or is in a second group of control plane entities of the network, and wherein at least one further flow of the two or more flows is in a second set of flows managed by the second control plane entity; an indication that the second control plane entity is in a different network and/or network region than the first session management entity; an address or reference or identification of the second control plane entity, wherein the address or reference or identification indicates to the first session management entity that it can obtain session management and/or QoS management control information from the second control plane entity for the at least one flow of the two or more flows of the multi-user application related to the multi-user group ID and/or the multi-user policy ID; the multi-user group ID and/or the multi-user policy ID; one or more flow IDs of flows of the multi-user application.

The method of the fourth aspect may have implementation forms that correspond to the implementation forms of the first session management entity of the second aspect. The method of the fourth aspect and its implementation forms achieve the same advantages as described for the first session management entity of the second aspect and its respective implementation forms.

A fifth aspect of this disclosure provides a computer program comprising instructions which, when the program is executed by a computer, cause the computer to perform the method of the third aspect or the fourth aspect or any implementation form thereof.

A sixth aspect of this disclosure provides a non-transitory storage medium storing executable program code which, when executed by a processor, causes the method according to the third aspect or the fourth aspect or any of its implementation forms to be performed.

In summary of the above aspects and implementation forms, this disclosure proposes an association of Coordinator or Participant roles to control plane entities of different PLMNs (or more generally in this disclosure of different networks or network regions or different groups of control plane entities), which may have one or more XR users interacting in the same VE (or more generally two or more flows of a multi-user application) using the resources of the different PLMNs. The disclosure may also enable any of the following types of interactions: the C-PLMN Coordinator PLMN manager (C-PLMN), e.g., the first control plane entity, and the Participating PLMN managers (P-PLMNs), e.g., the second control plane entity, may operate with an agreed multi-PLMN QoS Policy (or more generally, the multi-user QoS policy) and using the same Multi-PLMN QOS Flow Group Identifier (or more generally, the multi-user group ID) for the multiple flows of the XR users (or more generally, the two or more flows of a multi-user application); NFs cross X-PLMNs Managers interactions to handle QoS fulfillment failure and multi-PLMN QOS Policy adaption at each PLMN.

The following features are particularly described in this disclosure, for the example of PLMNs as the networks or network regions or groups of control plane entities.
Feature 1 (Multi-PLMN QoS (MPQ) policy establishment):
   PLMN Managers and AF interact for determination of Coordinator PLMN (C-PLMN) manager role, and Participating PLMNs (P-PLMNs) manager roles, among PLMNs serving UEs (or serving one UE with multiple QoS flows of a given XR application) in the same multi-modality XR application, or AF triggers PLMN Managers to determine their roles for a given set of UEs (and/or QoS Flows) of a given XR application
   PLMN Managers receive information from AF (and/or other PLMN manager) in order to determine or configure or bind a set (or list, or group) of QoS Flows of a given XR application to a Multi-PLMN QOS (MPQ) Policy, where all PLMN Managers serving the UEs and/or the multiple QoS Flows of the same UE are related to the same XR application (or same VE of an XR application) become aware of the MPQ Policy information to be used for such UEs and/or multiple QoS Flows (e.g., from the same UE) with such XR application.
Feature 2 (MPQ policy agreement and distribution):
   C-PLMN manager interacts with the P-PLMNs managers for distribution and/or agreement of Multi-PLMN QoS Policy parameters to be used by the multiple PLMNs when serving the UEs and/or QoS Flows (e.g., of the same UE) of the XR Application that are bind to the MPQ Policy among the PLMNs.
Feature 3 (MPQ Policy Changes in case of QoS Fulfillment Failure):
   NFs associated with C-PLMN and/or NFs associated with P-PLMNs interact across X-PLMN managers (e.g., an NF in a PLMN #1 interacts, i.e., exchange information, with a PLMN Manager of a PLMN #2) for performing tasks to:
      Handle QoS fulfillment failure (i.e., QoS failure treatment tasks) at a PLMN network (e.g., notifying about QoS non-fulfillment) and/or
      Adapt QoS parameters within agreed ranges of Multi-PLMN QOS for the QoS Flows that are associated with a QoS failure treatment (e.g., execute or trigger the Policy modification and/or PDU session modification).
Feature 4 (Freezing PDU Session related to MPQ Policy):
   C-PLMN manager or P-PLMN provide to NFs an indication for PDU Session and/or QoS Flow freezing;
   C-PLMN manager or P-PLMN or NF (handling the PDU Session and/or QoS Flow freezing of the UE) notifies the AF about such freezing when the PLMN-Manager cannot adapt the QoS support for the QoS Flow (i.e., the adjustment would be outside of agreed QoS requirement ranges in Multi-PLMN QoS Policy).

For simplicity the rest of the disclosure will refer to “PLMN Managers serving the UEs”, “MPQ Policy information to be used for such UEs”, but these are simplifications for: “PLMN Managers serving the UEs and/or multiple QoS Flows of the same UE”, “MPQ Policy information to be used for such UEs and/or multiple QoS Flows of the same UE”.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 shows a first control plane entity according to this disclosure.

FIG. 2 shows a first session management entity according to this disclosure.

FIG. 3 shows an exemplary Inter-PLMN scenario.

FIG. 4 shows an exemplary Intra-PLMN Region scenario.

FIG. 5 shows an exemplary mixed scenario with Inter-PLMN and Intra-PLMN Region.

FIG. 6 shows an exemplary embodiment based on a Multi-PLMN scenario with two different PLMNs.

FIG. 7 shows an example of a MPQ Policy establishment (feature 1).

FIG. 8 shows an example for MPQ policy agreement and distribution (feature 2).

FIG. 9 shows an example for MPQ Policy Changes in case of a QoS fulfilment failure (feature 3).

FIG. 10 shows an example for a freezing of a PDU Session and/or QoS Flows (feature 4).

FIG. 11 illustrates a method for managing QoS according to this disclosure.

FIG. 12 illustrates a method for supporting the management of QoS according to this disclosure.

### EXPLANATION OF TERMS USED IN THIS DISCLOSURE

Flow or QoS Flow: Abstraction to associate a data traffic to a certain QoS treatment.

QoS Flow Sessions or Session: Defines the logical association between the UE and a Data Network where the QoS Flows of such UE are grouped or managed.

CP entity of Multi-PLMN: This term is used in this disclosure to relate (or define, or describe) the multiple (or one or more) CP entity(ies) in any of the following situations (or configurations, or deployment options, or association, or scenario):
There are at least two different CP entities each belonging to a different PLMN (e.g., mobile operator) that are related to the management (or configuration, or control, or definition) of QoS Flows from multiple users (e.g., UEs) associated with the same application and/or of QoS Flows from the same user associated with the same application.
There are at least two different CP entities each belonging to a different Group of CP entities defined in the same PLMN (e.g., mobile operator) or each belonging to different intra-PLMN regions of the same PLMN, so that such CP entities are related to the management (or configuration, or control, or definition) of QoS Flows from multiple users associated with the same application and/or of QoS Flows from the same user associated with the same application.
There are at least three different CP entities controlling the QoS Flows from multiple users associated with the same application and/or of QoS Flows from the same user associated with the same application, where two of these entities belong each to a different Group of CP entities defined in the same PLMN (e.g., mobile operator) or each belonging to different intra-PLMN regions of the same PLMN, so that such CP entities are and one entity belongs to a different PLMN.

Multi-PLMN (or Multi-PLMN Environment): The term multi-PLMN denotes the existence of entities in any of the following situations (or configurations, or deployment options, or association, or scenario):
There are at least two different entities each belonging to a different PLMN (e.g., mobile operator).
There are at least two different entities each belonging to a different Group of entities defined in the same PLMN (e.g., mobile operator) or each belonging to different intra-PLMN regions of the same PLMN.
There are at least three different entities, where two of these entities belong each to a different Groups in the same PLMN (e.g., mobile operator) or each belonging to different intra-PLMN regions in the same PLMN, and one entity belongs to a different PLMN.

Session Management (SM) entities of Multi-PLMN: This term is used in this disclosure to relate (or define, or describe) the one or more entities involved in the session management of data traffic of users (e.g., UE(s)) related to a MPQ Policy, where such SM entities of Multi-PLMN are in any of the following situations (or configurations, or deployment options, or association, or scenario):
The SM entity of Multi-PLMN and the CP entity of a Multi-PLMN belong to the same PLMN.
The SM entity of Multi-PLMN and the CP entity of a Multi-PLMN belong to different PLMN.

Examples of SM entities are: SMF, AMF, RAN node, UE, UPF. When the SM entity of Multi-PLMN is a UE:
The SM entity of Multi-PLMN (i.e. UE) and the CP entity of a Multi-PLMN are located in the same PLMN;
The SM entity of Multi-PLMN (i.e. UE) and the CP entity of a Multi-PLMN are located in different PLMN;

Multi-PLMN QoS Policy (MPQ Policy): It is one or more, a set, or a group, or a list of parameters (or information) that define or describe the handling (or management, or enforcement, or control, or association, or configuration) of QoS requirements of one or more QoS Flows (or a list, or a group, or a set of QoS Flows) from multiple users associated with the same application and/or of QoS Flows from the same user associated with the same application where such QoS Flows from the multiple users and/or from the same user are being controlled by different CP entities of Multi-PLMN.

PLMN Manager: This term defines the CP Entity of Multi-PLMN with any of the following capabilities (and/or functionality, and/or role):
To control (or manage, or configure, or operate with) a Multi-PLMN QoS Policy.
Interacts with SM Entities of Multi-PLMN.
Interacts with one or more other PLMN Managers.
Interacts CP entities of Multi-PLMN for performing session management tasks and/or policy management tasks.
Interact with AF for information exchange related to MPQ Policy.

Interact: The term interact denotes the capability of an entity to provide and/or obtain information from another entity.

C-PLMN Manager (Coordinator PLMN Manager or Coordination Multi-PLMN Manager): This term defines a PLMN Manager able to perform (or execute, or control, or have the role of) the coordination (e.g., centralization of information collection, and/or centralization of decisions, and/or central point for information distribution to other entities) related to the MPQ Policy with other PLMN Managers (e.g., P-PLMN Managers) or SM entities of Multi-PLMNs. Some of the functionalities associated with the C-PLMN Manager (e.g., role) are any of the following:
A C-PLMN can centralize the interaction with the AF (e.g., be the main entity among the CP entities associated with a MPQ Policy to exchange information related to the MPQ Policy with the AF).
A C-PLMN can centralize the interaction with other PLMN Managers (e.g., be the main entity among the CP entities associated with the MPQ Policy that receives and sends information related to the MPQ Policy to other CP entities of Multi-PLMN).

P-PLMN Manager (Participating PLMN Manager or Participating Multi-PLMN Manager): This term defines a PLMN Manager able to control (or execute, or configure, or manage) a local MPQ Policy and obtain from and/or provide to the C-PLMN Manager the information related to the its local MPQ Policy and/or information relevant for the global MPQ Policy, and/or interact with SM entities of Multi-PLMNs, and/or interact with AFs.

XR Application: Similar terms to refer to this type of application: multi-modality application or multi-modality QoS Flows or multi-modality PDU sessions.

Multi PLMN QOS (MPQ) binding information: This term defines the information (or parameters) that relates (or associate, or map, or bind) a one or more (or a set of, or a group of, or a list of) QoS Flows from an application, to a MPQ Policy, where there are at least two QoS Flows that are each associated with a different UE or with the same UE and when there are different UEs, each UE is associated with a different PLMN Manager, and when the two QoS Flows are associated with the same UE, each QoS Flow are associated with a different PLMN Manager. Synonyms to this term are: MPQ Mapping information, MPQ provisioning information; MPQ Session information.

QOS Requirements (or QoS Characteristics): Defines one or more parameters related to the QoS to be associated with a data traffic. Examples of QoS Requirements or Characteristics are the same as listed in 3GPP TS 23.501 Clause 5.7, such as: 5G QOS Identifier (5Q1), Allocation and Retention Priority (ARP), Guaranteed Flow Bit Rate (GFBR), Maximum Flow Bit Rate (MFBR), GBR QOS Flow, Non-GBR QoS Flow, Packet Loss Rate, Packet Delay Budget (PDB), Averaging window, Maximum Data Burst Volume (MDBV).

Local MPQ policy: It is an MPQ policy comprising: MPQ Policy Section related to Multi-PLMN QoS Flow Group Identifier and the MPQ Policy Section related to QoS Flows managed by one PLMN Manager.

Global MPQ policy: An MPQ Policy comprising MPQ Policy Section related to Multi-PLMN QoS Flow Group Identifier and one or more MPQ Policy Section related to QoS Flows managed by one or more PLMN Managers associated with the same Multi-PLMN QoS Flow Group Identifier.

MPQ Policy Section (or Segment or Information Part) related to Multi-PLMN QoS Flow Group Identifier: One or more parameters (or information) from the MPQ Policy that are the same (e.g., are shared, or are common) to all PLMN Managers associated to the same Multi-PLMN

QoS Flow Group Identifier. Synonyms for the MPQ Policy Section related to Multi-PLMN QOS Flow (MPQ) Group Identifier are: MPQ Policy Section for all PLMN Managers; MPQ Policy Section related to Global Information; MPQ Policy Section related to Overall Information; MPQ Policy Section related to Shared Information.

MPQ Policy Section (or Segment, or Information Part) related to QoS Flows: One or more parameters (or information) related to QoS Flows managed by one or more PLMN Managers that can be either maintained local at a single PLMN Manager (e.g., is not shared with other PLMN Managers) or it can be provided by one PLMN Manager to one or more other PLMN Managers (e.g., the information is shared with other PLMN Managers associated with the same Multi-PLMN QoS Flow Group Identifier). Synonyms for the MPQ Policy Section related to QoS Flows: MPQ Policy Section for individual PLMN Managers; MPQ Policy Section related to QoS Service; MPQ Policy Section related to Local Multi-PLMN.

MPQ Policy Section (or Segment, or Information Part) related to Agreements (or Configurations): One or more parameters (or information) related to configurations that PLMN Managers have to use (or shall use, or should use) when a MPQ policy is established. In this case, the PLMN managers obtain the parameter(s) (or the values to be used with the parameters) either via configuration by a Management Entity (e.g., OAM) or by interacting with a C-PLMN manager that can provide such parameter (or parameter values).

MPQ Agreement information: One or more parameters (or information) related to the MPQ Policy that are defined (or their values are defined) according to legal agreements (e.g., SLA Agreement) among the operators of a Multi-PLMN environment.

MPQ Agreement information or MPQ Configuration information: One or more parameters (or information) related to the MPQ Policy that are defined (or their values are defined) according to any of the following:
By configuration via a Management Entity.
By configuration related to an MPQ Agreement information.
By information related to the interaction among PLMN Managers.

AF-MPQ Configuration: One or more parameters (or information) related to MPQ Policy information that are defined (or their values are defined) by configuration at the AF

### DETAILED DESCRIPTION OF EMBODIMENTS

For simplicity, this disclosure refers to the case where the at least two QoS Flows (or simply flows) mentioned throughout the disclosure are each associated with a different UE. However, the same mechanisms, which are applied for the case where the at least two flows are associated with the same application, but related to different UEs and different PLMN Managers, are also applicable to the case where the at least two flows belong to the same UE, wherein each flow of the same UE is associated with a different PLMN Manager and is related to the same application.

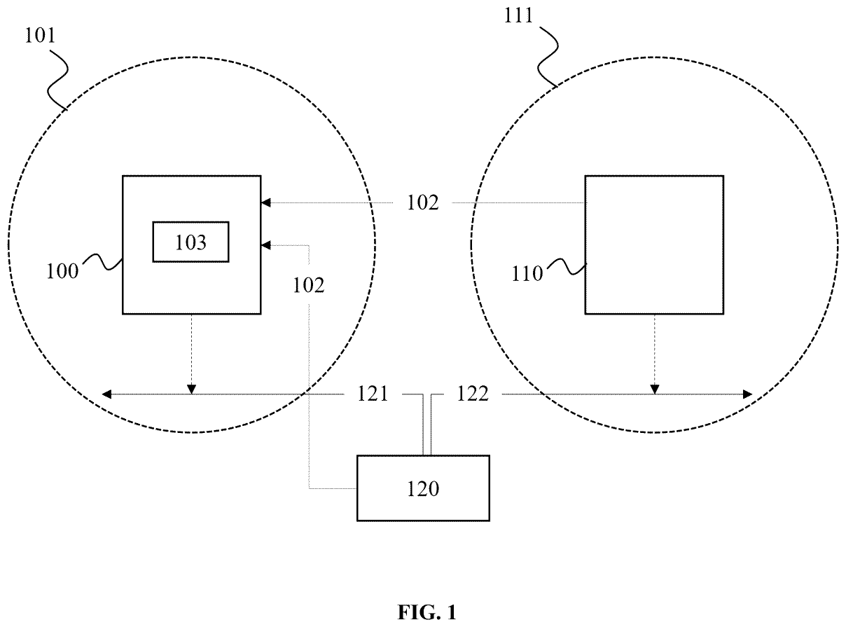

FIG. 1 shows a first control plane entity 100 according to this disclosure. The first control plane entity is configured to manage QoS of a first set of one or more flows of a multi-user application 120. The first control plane entity 100 is in a first network and/or in a first network region 101, or is in a first group of control plane entities of a network (e.g., the first network). The first control plane entity 100 may be a PCF of the first network and/or first network region 101. The first control plane entity 100 may be a PLMN manager, in particular, if the first network and/or first network region 101 is a first PLMN. The first control plane entity 100 could be a C-PLMN or a P-PLMN.

The first control plane 100 entity is configured to obtain binding information 102 (also referred to as MPQ binding information in this disclosure), for instance, from an AF related to the application 120, or from a second control plane entity 110 or from any other control plane entity. The binding information 102 indicates a multi-user group ID, which is related to two or more flows 121, 122 of the multi-user application 120. At least one flow 121 of the two or more flows 121, 122 is in the first set of flows managed by the first control plane entity 100, and at least one flow 122 of the two or more flows 121, 122 is in a second set of flows managed by the second control plane entity 110. The second control plane entity 110 is in a second network and/or in a second network region 111, or is in a second group of control plane entities of the network. For instance, the second control plane entity 110 may be in a second PLMN.

The first control plane entity 100 is further configured to establish a multi-user QoS policy 103 (also referred to as MPQ Policy in this disclosure) that defines first information to be used for the management of the two or more flows 121, 122 of the multi-user application 120, which are related to the multi-user group ID. The multi-user QoS policy 103 is associated with the multi-user group ID and/or a multi-user policy ID. The first control plane entity 100 may establish the multi-user QoS policy 103 based on the binding information 102.

The first control plane entity 100 may be a PCF, which is extended with the capability to perform a C-PLMN or P-PLMN functionality, so as to interact with PCFs of other PLMNs (e.g., the second control plane entity 110) and/or authorized NFs (e.g., SMFs/AMFs) of other PLMNs, in order to exchange and/or align QoS requirements of a multiple flows (e.g., from a group of users that are physically located in each of their HPLMNs, or from a single UE that is using resources from multiple PLMNs for the same application), however, the traffics of the UE(s) are related to the same VE (i.e., multi-modality XR application).

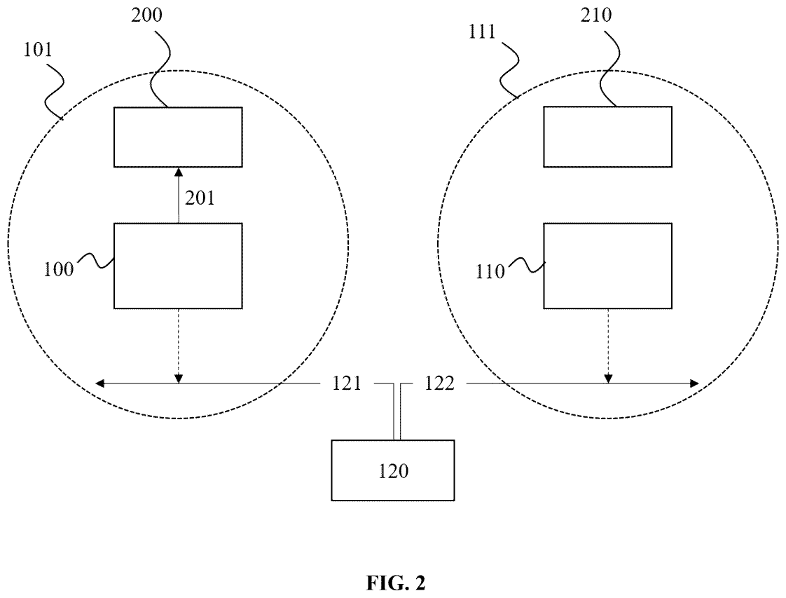

FIG. 2 shows a first session management entity 200 according to this disclosure. The first session management entity is configured to support the management of QoS of at least one flow 121 of two or more flows 121, 122 of a multi-user application 120. The first session management entity 200 is in a first network and/or in a first network region 101, or is associated with a first group of control plane entities of a network. For instance, the first session management entity 200 may be in a first PLMN. The first session management entity 200 may be an SMF, or UE, or AMF or RAN node, or UPF. The two or more flows 121, 122 of the multi-user application 120 are related to a multi-user group ID and/or a multi-user policy ID associated with a multi-user QoS policy 103.

The first session management entity 200) is configured to receive a support message 201 from a first control plane entity 100, particularly the control plane entity 100 shown in FIG. 1. The support message 201 includes one or more of the following.
An ID of the first control plane entity 100. The first control plane entity 100 is in the first network and/or in the first network region 101 or in the first group of control plane entities, e.g., in the first PLMN. The at least one flow 121 of the two or more flows 121, 122 of the multi-user application 120 is in a first set of flows managed by the first control plane entity 100.
An ID of a second control plane entity 110. The second control plane entity 110 is in a second network and/or in a second network region 111, or is in a second group of control plane entities of the network. For instance, the second control plane entity 110 may be in a second PLMN. At least one further flow 122 of the two or more flows 121, 122 is in a second set of flows managed by the second control plane entity 110.
An indication that the second control plane entity 110 is in a different network and/or network region (or PLMN) than the first session management entity 200.

An address or reference or identification of the second control plane entity 110. The address or reference or identification indicates to the first session management entity 200 that it can obtain session management and/or QoS management control information from the second control plane entity 110 for the at least one flow 121 of the two or more flows 121, 122 of the multi-user application 120 related to the multi-user group ID and/or the multi-user policy ID.
The multi-user group ID and/or the multi-user policy ID.
One or more flow IDs of flows of the multi-user application 120.

The first control plane entity 100, and/or the second control plane entity 110, and/or the first session management entity 200, and/or the second session management entity 210 may respectively comprise a processor or processing circuitry (not shown) configured to perform, conduct or initiate the various operations of the respective entity 100, 110, 200, 210 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors.

The first control plane entity 100, and/or the second control plane entity 110, and/or the first session management entity 200, and/or the second session management entity 210 may respectively further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the respective entity 100, 110, 200, 210 to be performed. In one embodiment, the processing circuitry comprises one or more processors and a non-transitory memory connected to the one or more processors. The non-transitory memory may carry executable program code which, when executed by the one or more processors, causes the respective mobile network entity 200, 220 to perform, conduct or initiate the operations or methods described herein.

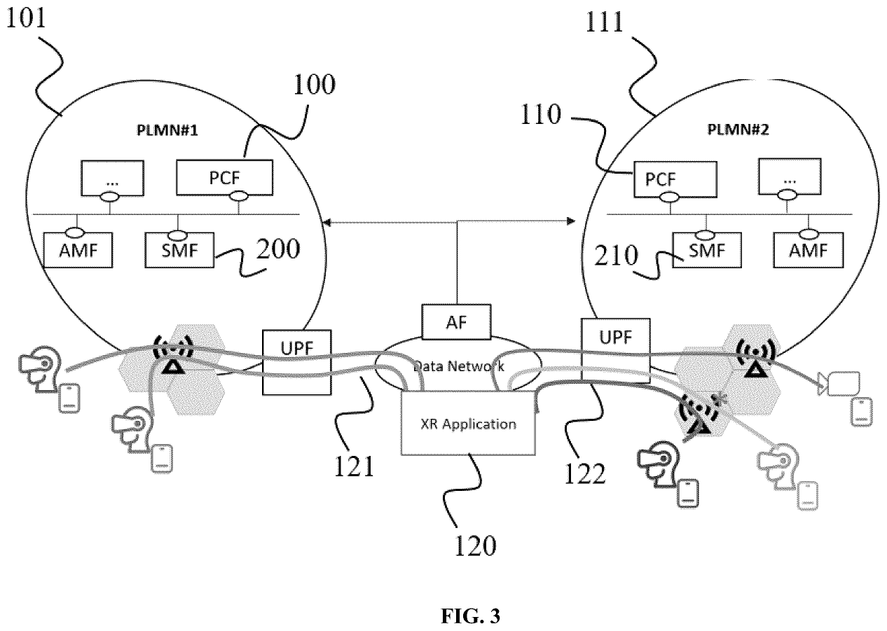

FIGS. 3-5 shows system architectures or scenarios, to which the solutions of the present disclosure are applicable. In these scenarios, the control plane entities 100 and 110 may be PCFs of different networks or network regions or PLMNs or groups of control plane entities. The session management entities 200 and 201 may be SMFs of the different networks or network regions 101, 111 or PLMNs or associated with the different groups of control plane entities. The application 120 may be an XR application and may be associated with an AF. The two or more flows 121, 122 may be QoS flows of the XR application for different users (UEs) in the different networks or network regions 101, 111 or PLMNs. Nevertheless, this does not exclude that the two or more flows of the XR application belong to the same UE but are each associated with different networks or network regions 101, 111 or PLMNs.

FIG. 3 depicts the scenario of a multi-user multi-modality XR application (or METAVERSE application) when the users of the XR application are being served by different mobile operators (i.e., PLMN #1 and PLMN #2). FIG. 3 also shows the mobile network architecture with the control plane NFs (e.g., PCF 100, 110, SMF 200, 210, and AMF) as well as user plane entities (e.g., UPF, RAN nodes).

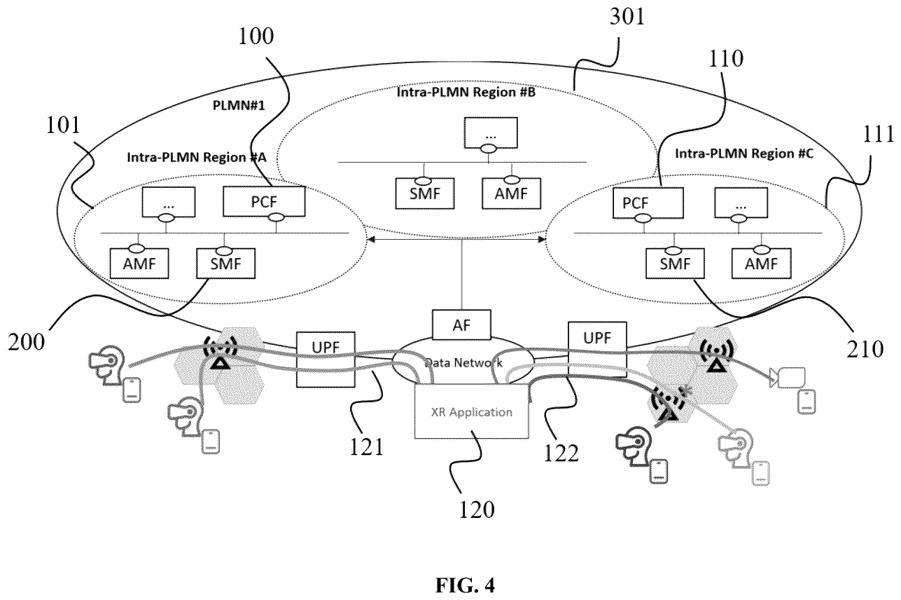

FIG. 4 depicts the scenario of a multi-user multi-modality XR application (or METAVERSE application) when the users of the XR application are being served by the same PLMN but by different PCFs 100, 110 associated with different intra-PLMN regions. The scenario in FIG. 4 shows three intra-PLMN regions: #A, #B, #C. In an intra-PLMN region there is a set of CP NFs that control the connections of the users that are associated with that physical region. For instance, SMFs 200, 210 and AMF can be associated with a serving area or service area. PCFs 100, 110 are also associated with PCF groups that manage a set of user's identifiers (SUPI). FIG. 4 also shows the mobile network architecture with the UP entities (e.g., UPF, RAN nodes).

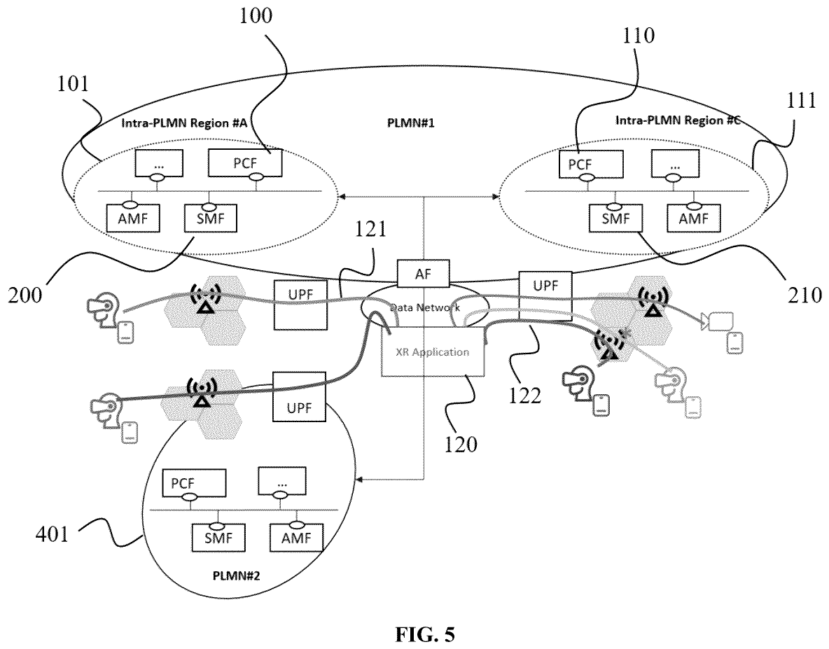

FIG. 5 depicts the scenario of a multi-user multi-modality XR application (or METAVERSE application) when the users of the XR application are being served by the same PLMN but by different PCFs 100, 110 associated with different intra-PLMN regions (and/or PCF groups) as well as by PCFs 100, 110 from different PLMNs. The scenario in FIG. 5 shows PLMN #1 with two intra-PLMN regions (or PCF groups) and PLMN #2. The users of the XR application are being served by the different PLMNs as well as by different controlling entities of PLMN #1 in different regions of the network.

In all scenarios, the following applies.

In an intra-PLMN region there is a set of CP NFs that control the connections of the users that are associated with that physical region. For instance, SMFs 200, 210 and AMF can be associated with a serving area or service area. PCFs 100, 110 are also associated with PCF groups that manage a set of user's identifiers (SUPI). FIG. 3-5 also show the mobile network architecture with the UP entities (e.g., UPF, RAN nodes). It is possible that PCF groups might be created independent from the intra-PLMN region or they are also bound to the intra-PLMN region definition or they are able to control different intra-PLMN regions.

The PCF 100, 110 is the NF responsible for properly managing the QoS Requirements of flows that users from an XR applications can have in a mobile operator. SMF 200, 210 is the NF responsible for managing the PDU sessions where the flows (e.g., QoS flows) of the users are transported in the UP of the mobile network. The QoS requirements to be enforced in the Qos Flows are then configured at the UP entities such as UPF (via SMF-UPF interactions), and RAN nodes/UE (via SMF-AMF to RAN/UE interactions).

The AF is the NF that is responsible to providing to the mobile operator(s) the QoS requirements for a group of QoS flows (i.e., the abstraction defined in mobile networks to enclose the data traffic of the users). It is assumed that the AF related to the XR application 120 shown in FIG. 3-5 is aware that the multiple users are using, or interacting in the same virtual environment, or participating, or interacting in the same virtual room. The AF is also aware that such multiple users are (a) being served by one PCF of each different PLMN in case of FIG. 3, (b) in case of FIG. 4 such users are being served by different PCFs in multiple intra-PLMN regions or from multiple PCFs groups but all the PCFs are in the same PLMN, and (c) users are being served by multiple at least two PCFs belonging to the same PLMN where each PCF serves a different intra-PLMN region or a different set of users (e.g., PCFs in different PCF Groups) and one PCF serving the users is from a different PLMN.

This disclosure assumes for all the scenarios that the AF is trusted by the operator and is aware of each PCF serving their users, either in inter-PLMN scenario and/or in intra-PLMN regions scenario.

Failing to align the QoS requirements among the mobile operators (i.e., PLMNs) serving these users or among the PCFs from a single PLMN serving the users in the intra-PLMN regions may lead the unsatisfied users of such XR application, because the users cannot properly interact (e.g., have a synchronized hand-shake) with the other users.

In the following, exemplary embodiments of this disclosure are described.

A proposal of this disclosure is to define the PLMN Manager capability (or functionality) for CP entities of Multi-PLMNs that have XR user(s) (or, UE(s) with XR application traffic, or any other demanding type of traffic) interacting in the same Virtual Environment (VE) (or the UEs of the application are interacting among each other within the same application). Additionally, a PLMN Manager can be associated with the Coordinator or Participant roles, where the C-PLMN (Coordinator PLMN) manager and the one or more P-PLMNs (Participating PLMNs) managers perform any of the following:
Operate with (or control, or manage, or take decisions, or perform tasks based on) an agreed (e.g., a common, or a shared) Multi-PLMN QOS (MPQ) Policy.
Interact with session management (SM) entities of multi-PLMNs in order to handle QoS fulfillment failure and/or maintenance for the QoS Flows associated with a Multi-PLMN QoS Policy among (e.g., common to) the PLMN Managers.
Interact among the each other (e.g., C-PLMN interacts with each P-PLMN; and/or one P-PLMN interacts with one or more other P-PLMNs as well as with the C-PLMN) to exchange relevant information associated with the MPQ Policy and/or the QoS fulfillment failure and/or maintenance for the QoS Flows associated with a Multi-PLMN QoS Policy among (e.g., common to) the PLMN Managers.
Interact with AF to obtain or provide relevant information to the MPQ Policy.

There are four features (or capabilities, or functionalities) associated with the PLMN Managers and their management (or control, or enforcement, or coordination) of the MPQ Policy. These features are listed above in the summary section and are described in more detail below:

Feature 1—Multi-PLMN QoS (MPQ) Policy Establishment: This feature focus on one or more PLMN Managers interactions with the AF for executing any of the following:
Determination of C-PLMN manager role and P-PLMNs manager roles among the Multi-PLMNs associated with: the same group of UEs interacting among each other at the application level (e.g., in XR application the UEs may be participating of the same virtual environment such as UE with avatars interacting in a conference or gaming), or the same group of UEs interacting in the same multi-modality application, or the at least two flows of the same UE for the same multi-modality application, where each flow is related to a different multi-PLMN.
One or more PLMN Managers obtain from AF or from a C-PLMN Manager the Multi PLMN QOS (MPQ) binding information.
One or more PLMN Manager uses the Multi PLMN QOS (MPQ) binding information obtained from AF or from the C-PLMN Manager to create (or define, or establish, or configure, or instantiate) a local and/or global MPQ Policy to be used by the PLMN Manager associated with the QoS Flows included in the MPQ binding information, where:
   A local MPQ policy has a set (or a list, or a subset) of parameters that belong only to the PLMN manager and are not visible by (or shared with, or communicated to, or sent to, or provided to) another PLMN Manager (e.g., the list of QoS Flows identification or the Flow Description associated with QFIs managed by the P-PLMN that are associated with a Multi-PLMN QoS Flow Group Identifier but are not visible to the C-PLMN Manager).
   A global MPQ Policy has information related to all PLMN Managers associated with the Multi-PLMN QoS Flow Group Identifier (e.g., the case where the C-PLMN has the list of all QoS Flow identifications, QFI, mapped to each PLMN Manager that are associated with the same Multi-PLMN QoS Flow Group Identifier).
One or more P-PLMN Managers provide to the C-PLMN manager an indication that the P-PLMN Manager participates in the same Multi-PLMN QOS Flow Group Identifier of C-PLMN Manager. Examples of such indication are:
   P-PLMN provides to the C-PLMN, the Multi-PLMN QOS Flow Group Identifier it received from the AF, and C-PLMN identifies that it is also in the same group;
   Using event-based mechanisms, the P-PLMNs subscribe to events provided by the C-PLMN using the Multi-PLMN QoS Flow Group Identifier (MPQG or MPQFG ID) in the subscription, therefore, this subscription with the MPQFG identifier is the indication of the participation in the same group).

Feature 2 (MPQ Policy Agreement and Distribution): C-PLMN manager interacts with the P-PLMNs managers for distribution and/or agreement of multi-PLMN QoS Policy to be used in the multiple PLMNs. The interactions among PLMN Managers can be any of the following:
The C-PLMN Manager (interacts based on any of the following):
   Obtains from the P-PLMN Managers a confirmation of activation of a MPQ Policy, for instance by receiving from P-PLMN Managers the MPQG ID and/or the global MPQ Policy Identification;
   Provides to the P-PLMN Managers the MPQG ID and/or the global MPQ Policy Identification (e.g., MPQP ID) and receives back an indication from the P-PLMN Managers that they belong to the same MPQG ID and/or the same global MPQP ID;
   This received information by C-PLMN allows the PLMN Managers to associate to an MPQ Policy the identification of other PLMN Managers sharing, or operating with the same MPQ Policy (if this association has not been done before).
The C-PLMN Manager (interacts based on any of the following):
   Provides to the P-PLMN Managers the MPQG ID and/or the global MPQP ID and/or requests the parameters (and/or parameters and their associated values and/or the information) related to the MPQ Policy Section related to Agreements that is stored by (or that is managed by, or that is configured at) the P-PLMN Managers;
   If the P-PLMN Manager verifies that it participates to the same MPQG ID and/or MPQP ID, the P-PLMN Manager provides the requested information (e.g., the parameters (and/or parameters and their associated values and/or the information) related to the MPQ Policy Section related to Agreements) to the C-PLMN Manager.
The C-PLMN Manager (interacts based on any of the following):
   Determines the MPQ parameters (and/or the parameters and their associated values) to be used (or to be configured, or to be associated with) an MPQG ID and/or MPQP ID.
   Provides to the P-PLMN Managers associated with (or sharing, or related to, or belonging to) the same MPQG ID and/or MPQP ID the determined MPQ parameters.

After the exchange of messages among the PLMN Managers, all the PLMN Managers will be configured or will store the same MPQ parametrization for the same MPQG ID and/or MPQP ID.

Feature 3 (MPQ Policy Changes in case of QoS Fulfillment Failure): NFs associated with C-PLMN (e.g., SM entities of Multi-PLMN related to C-PLMN Manager) and NFs associated with P-PLMNs (e.g., SM entities of Multi-PLMN related to P-PLMN Manager) are allowed to perform cross X-PLMN managers interactions (e.g., the SM entity associated with one PLMN Manager can interact another PLMN Manager) for joint treatment of QOS fulfillment failure at local PLMN and adaptation QoS parameters within agreed ranges of Multi-PLMN QoS. The PLMN Managers and the SM entities of Multi-PLMN interact according to any of the following:
The PLMN Manager provides to the one or more SM entities of the Multi-PLMN a MPQ Support indication 201. This MPQ Support indication 201 comprises any of the following:
   A list of (or set of or group or one or more) PLMN Manager identification(s) and/or PLMN Manager reference point (e.g., address of the PLMN Manager) that can control (e.g., that can initiate PDU session Modification procedures, or initiate QoS parameters modifications in QoS Flows, or request the release of the PDU Session) one or more QoS Flows related to the local MPQ Policy related to such SM entity(ies) of multi-PLMN
   A list of (or set of or group or one or more) PLMN Manager identification(s) and/or PLMN Manager reference point (e.g., address of the PLMN Manager) that the SM Entity of the Multi-PLMN can interact with (e.g., provide the QoS Problem Notification);
   The MPQG ID and/or MPQP ID related to one or more PLMN Manager identification(s) and/or PLMN Manager reference point
   One or More QoS Flow IDs (e.g., QFI) related to the MPQG ID and/or MPQP ID
   One or More QoS Flow IDs (e.g., QFI) related to PDU Session ID
   One or More QoS Flow IDs (e.g., QFI) and/or PDU Session ID(s) related to the MPQG ID and/or MPQP ID that can be controlled by a PLMN Manager (e.g., the mapping of the QFIs to PLMN Manager identification, with the indication that such PLMN Manager can request changes in such QFIs)
   One or More QoS Flow IDs (e.g., QFI) and/or PDU Session ID(s) related to the MPQG ID and/or MPQP ID that the SM Entity of multi-PLMN is allowed to provide information to a PLMN Manager (e.g., the mapping of the QFIs to PLMN Manager identification, with the indication that the SM Entity of the multi-PLMN can provide information about such QFI to the PLMN Manager).
One SM Entity of Multi-PLMN can forward and/or provide MPQ Support indication 201 to other SM entities of the same Multi-PLMN, to enable all SM entities of the Multi-PLMN controlling or related to the same PDU Session, to obtain the MPQ Support Information.
Based on the MPQ Support indication 201, the SM Entity of the Multi-PLMN provides to the PLMN Manager a QoS Problem Notification. The QoS Problem Notification is one or more information that denotes that for a given QoS Flow (and/or PDU Session) the supported QoS requirements (or parameters) at the mobile network are deviating (or are outside, or exceeded) the acceptable ranges of deviation defined in the MPQ Policy related to the QoS Flow. The QoS Problem Notification comprises any of the following:
   MPQG ID and/or MPQP ID
   PDU Session Identification (PDU Session ID) and/or QoS Flow Identification (QFI, or Flow Descriptor ID)
   Parameter type (or parameter name) where deviation was observed
   Value of the parameter and/or value of the deviation from configured value in the MPQ Policy
   Flag denoting threshold of acceptable deviation has been crossed.
PLMN Manager obtaining a QoS Notification can perform any of the following:
   Determine whether the freezing of the PDU Session associated with the QoS Problem Notification needs to be activated
   Determine new parametrization for the MPQ Policy Section related to QoS Flows that is associated with the MPQ Policy (MPQG ID and/or MPQP ID) indicated in the obtained QoS Problem Notification;
   Provide updated MPQ Policy (e.g., the updated parametrization of MPQ Policy Section related to QoS Flows) to the PLMN Managers associated with the MPQ Policy;
   Provide to the SM entity of the same Multi-PLMN and/or to SM entities of Multi-PLMNs associated with other PLMN Managers a trigger for executing procedures related to the PDU Session management (such as PDU Session Modification or PDU Session Release) that are further associated with the updated MPQ Policy;
   Obtain from one or more SM entity of Multi-PLMN confirmation of changes in the PDU sessions related to the updated MPQ Policy.

Feature 4 (Freezing PDU Session related to MPQ Policy): PDU Session freezing at UE and AF notification of freezing when PLMN that has QoS Support out of acceptable ranges of deviation defined in the in Multi-PLMN QoS Policy. Any of the following interactions among the entities of this disclosure can happen:
The PLMN Manager determines that a PDU Freezing should be activated (e.g., when there is no alternative to update the QoS parameters of the MPQ Policy).
The PLMN Manager provides an indication to release the PDU Session with the activation of the Session Retry Back off timer to the SM Entity of the Multi-PLMN (e.g., the SMF) related to the QoS Flow and/or PDU session associated with a QoS Problem Notification.
The PLMN Manager provides an indication to freeze one or more QoS Flows of a PDU. Session with the activation of the Session Retry Back off timer to the SM Entity of the Multi-PLMN (e.g., the SMF) related to the QoS Flow and/or PDU session associated with a Qos Problem Notification.
The SM entity of the Multi-PLMN that received an indication for release the PDU Session or the indication to freeze one or more QoS Flows of a PDU Session in both cases with the activation of the Session Retry Back off timer provides to the UE associated with such PDU session such Session Retry Back off.
The UE uses the Session Retry Back off timer to stop trying to establish new PDU sessions for the data traffic during the interval of the back of timer or to stop transmitting data traffic related to the frozen QoS Flow(s) during the interval of the back off timer without releasing the PDU Session.
The PLMN Manager obtains from the SM entity of the Multi-PLMN a confirmation of PDU Session and/or QoS Flow freezing.
The PLMN manager provides to the AF related to the frozen PDU Session and/or QoS Flow(s) an indication of PDU Session and/or QoS Flow(s) freezing activation and/or the used freezing back off timer for such PDU and/or QoS Flow that has been frozen.

In this disclosure, as reference for the embodiments, a 5G Core Network Architecture defined in 3GPP TS 23.501 may be used. The following may be considered in all embodiments.
C-PLMN Manager and P-PLMN Managers capabilities are implemented in the PCF NF.
Embodiments for SM Entities of Multi-PLMN are: SMF, AMF, UPF, RAN Node, UE.
Embodiments for CP entity of Multi-PLMN are: SMF or AMF

An embodiment for an MPQ Policy comprises any of the following parameters:

### MPQ Policy Section Related to Overall Information

Global MPQ Policy identification or MPQ Policy Identification (e.g., identification that is common or unique among all associated the PLMN Managers).
Local MPQ Policy identification (e.g., the identification is used only by the PLMN Manager controlling or managing or that instantiated the MPQ Policy).
Multi-PLMN QoS Flow (MPQ) Group identifier (e.g. this is the global or unique identifier related to all the multi-PLMN entities that are associated to a same MPQ Policy).
One or more (or a list of, or a set of, or a tuple of) identification of the application session context per PLMN Manager.
Intra-MPQ Group Identifier (e.g., this is an identifier used when within the same PLMN there are multiple PLMN Managers serving the flows (or UEs) of an application associated with MPQ Policy (or being managed, or being controlled, or operating with an MPQ Policy).
A list of (or a set of, or one or more of) Intra-PLMN Group Identification (e.g., this is an identifier or identification used within for PLMN or in a Group ID or in intra-PLMN region) associated with a list of QoS Flows (or QoS Flow Descriptions or QoS Flow Descriptors).
List of (one or more, a set of) Multi-PLMN identification (e.g., for PCFs from different PLMNs or inter-PLMN the identification is the PLMN ID; for multiple PCFs of the same PLMN or intra-PLMN the identification can be the group ID or an intra-region identification (e.g., list of tracking area information, or a geographical location information, or a spatial area description)).
List of (or mapping of, or one or more, or set of) PLMN Managers identification and/or reference point (e.g., an address that allows a consumer of the PLMN Manager to request or invoke its services) associated with the MPQ Policy (e.g., have a MPQ Policy with the same MPQ Group identifier).
List of (or mapping of, or one or more, or set of) PLMN Managers and their PLMN identification (e.g., PLMN ID) or an intra-PLMN identification (e.g. Group ID or Region ID).
List of (or mapping of, or one or more, or set of) PLMN Managers identification and their associated PLMN Manager role for the MPQ Policy (e.g., a PLMN Manager can have a C-PLMN Manager role or P-PLMN Manager role).
Application identification (e.g., Application ID or Application Context Identification).
AF identification and/or reference point and/or address

### MPQ Policy Section Related to Agreements

For one or more PLMN Manager (or PLMN Manager identification), list of (or set of, or mapping of, or one or more) NF identification and/or reference point that is authorized and/or allowed to interact directly with such PLMN Manager.
Acceptable ranges of deviation for QoS Requirements.
Acceptable ranges of deviation for Alternative QoS Requirements.
PDU Session Release Threshold due to QoS Degradation.
PDU Session Retry Back off timer.
Enforcement Strategy (e.g., of possible values for this parameter or field are any of the following: No Alignment, C-PLMN Manager Lead Alignment, and Any PLMN Manager Lead Alignment).
Policy Distribution Strategy (e.g., of possible values for this parameter or field are any of the following: SLA based Parametrization, Harmonized Parametrization, C-PLMN based Parametrizations).

### MPQ Policy Section Related to QoS Flows

List of (set of, or one or more) QoS Flow Identification (QFIs) associated with the MPQ Policy.
List of UE identification associated with the MPQ Policy.
List of QoS Flow identification and/or Flow Description associated with a UE identification.
Identification of a Flow Description (or Flow Descriptor).
List of (or one or more, or set of) PDU Session identification.
List of (or one or more, or set of) QFIs and/or UE identification and/or Flow Description identification associated with a PDU Session identification.
QoS Requirements per Flow Description, or Flow Description associated with a QFI, or per QFI.
Alternative QoS Requirements per Flow Description or Flow Description associated with a QFI, or per QFI.
For one or more PLMN Manager (or PLMN Manager identification) associated with the MPQ policy, List of (set of, or one or more) QFIs associated with the MPQ Policy that are being served by (or controlled by, or managed by, or bind to) the PLMN Manager.
For one or more PLMN Manager (or PLMN Manager identification) associated with the MPQ policy, QoS Flow Group identifier associated with the QoS Flows related to (or about, or associated with) the PLMN Manager.

An embodiment for the MPQ binding information comprising any of the following:
An identification (e.g., Multi-PLMN QoS Flow-MPQ-Group Identifier or Identification) to be associated with the list of (or group of, or set of, or multiple) QoS Flows from multiple users (UE) or from the same UE associated with an application (e.g., an application identification) and with CP entities of Multi-PLMNs (e.g., identification of the PLMN Managers serving such flows (and/or UEs)).
Intra-MPQ Group Identifier (e.g., this is an identifier used when within the same PLMN there are multiple PLMN Managers serving the flows (and/or UEs) of an application related to CP entities of multi-PLMN.
List of (or mapping of, or one or more, or set of) PLMN Managers identification and/or reference point (e.g., an address that allows a consumer of the PLMN Manager to request or invoke its services) associated with the same MPQ Group identifier.
List of (or set of, or one or more of) the QoS Flow information associated with MPQ Group Identifier.
One or more list of (or set of, or one or more of, or mapping of, or table of, or tuple with) QoS Flow information associated with (or bind to, or belonging to, or served by) PLMN Manager identification.
The list of (or the one or more, or the set of, or the group of) PLMN Manager identification with associated C-PLMN and/or P-PLMN role (or capability, or functionality), this indicates that a PLMN Manager has a C-PLMN or a P-PLMN role related to (e.g., when participating in) the Multi-PLMN QoS Flow Group Identifier.
A list of (or a set of, or one or more of) Intra-PLMN Group Identification (e.g., this is an identifier or identification used within for PLMN or in a Group ID or in intra-PLMN region) associated with a list of QoS Flows (or QoS Flow Descriptions or QoS Flow Descriptors).
Application identification (e.g., Application ID or Application Context Identification).
AF identification and/or reference point.
One or more (or a list of, or a set of) Flow Description (or Flow Descriptor).
One or more (or a list of, or a set of) QoS requirements for Flow Description (or Flow Descriptor).
One or more (or a list of, or a set of) Alternative QoS Requirements for Flow Description (or Flow Descriptor).
(Optional) PDU Session Release Threshold due to QoS Degradation.
(Optional) PDU Session Retry Back off timer.
Acceptable ranges of deviation for QOS Requirements and/or for Alternative QoS Requirements, where the Acceptable Ranges of Deviation can comprise (or be configured by) any of the following forms:
   Per QoS Flow identification (e.g., QFI); in this case, for each QoS Requirement defined for the QFI, there is a definition (or configuration) of acceptable ranges of deviations;
   Per type of QoS Flow (e.g., for QoS Flows associated with multi-modality type of traffic), in this case all the QoS Flows (e.g., one or more QFIs) that are associated with the same type of QOS Flow have the same QoS requirements, and their associated acceptable ranges.
   Per type of QOS Requirement, in this case there are acceptable ranges of deviations defined per type of QoS Requirement and any QoS Flow (QFI) that is configured with the same type of QoS Requirement (e.g., 5QI parameter) will have the same values for the acceptable ranges of deviations;
   Additionally examples of the actual configuration, e.g., information defining the possible variation of values of the ranges of deviation (or thresholds), can be defined as follows:
      Maximum increase and/or decrease in terms of percentage from the agreed value (e.g., PDB agreed 10 ms, maximum 10% increase, maximum 30% decrease).
      Maximum and/or minimum values for QoS requirement type.
      (e.g., GFBR agreed 5 Mbps, maximum change to 6 Mbps (e.g., upper limit)), minimum change to 4 Mbps (e.g., lower limit)).
      Alternative values for a QoS Requirement (e.g., Agreed 5QI1, list of alternative 5QIs).

The MPQ Agreement (or MPQ Configuration) contain any of the following parameters:
MPQ Agreement identification: it is possible that the MPQ Agreement information associates a MPQ Agreement identification to each possible combination of parametrizations among the mobile operators participating in an SLA Agreement with MPQ Policy related information.

### MPQ Policy Section Related to Overall Information

List of (or mapping of, or one or more, or set of) PLMN Managers identification and/or reference point (e.g., an address that allows a consumer of the PLMN Manager to request or invoke its services) associated with the MPQ Policy (e.g., have a MPQ Policy with the same MPQ Group identifier).
List of (one or more, a set of) Multi-PLMN identification (e.g., for PCFs from different PLMNs or inter-PLMN the identification is the PLMN ID; for multiple PCFs of the same PLMN or intra-PLMN the identification can be the group ID or an intra-region identification (e.g., list of tracking area information, or a geographical location information, or a spatial area description)).
List of (or mapping of, or one or more, or set of) PLMN Managers and their PLMN identification (e.g., PLMN ID) or an intra-PLMN identification (e.g. Group ID or Region ID).
List of (or mapping of, or one or more, or set of) PLMN Managers identification and their associated PLMN Manager role for the MPQ Policy (e.g., a PLMN Manager can have a C-PLMN Manager role or P-PLMN Manager role).
Application identification (e.g., Application ID).
AF identification and/or reference point.

### MPQ Policy Section Related to Agreements)

For one or more PLMN Manager (or PLMN Manager identification), list of (or set of, or mapping of, or one or more) NF identification and/or reference point that is authorized and/or allowed to interact directly with such PLMN Manager.
Acceptable ranges of deviation for QOS Requirements.
Acceptable ranges of deviation for Alternative QoS Requirements.
PDU Session Release Threshold due to QoS Degradation.
PDU Session Retry Back off timer.
Enforcement Strategy.
Policy Distribution Strategy.

In addition to be used for the determination of C-PLM and P-PLMN Manager roles, the MPQ Agreement or MPQ Configuration also defines the parametrization (or the information or the values of parameters) for information in the MPQ Policy Section related to Agreements. In this case, the examples below show the following parameters (or information) related to the MPQ Policy that are defined or configured in the MPQ Configuration (or Agreement):
For one or more PLMN Manager (or PLMN Manager identification), list of (or set of, or mapping of, or one or more) NF identification and/or reference point that is authorized and/or allowed to interact directly with such PLMN Manager, where such NFs are SM Entities of the multiple-PLMN.
For (a) each application identification, (b) or for one or more PLMN Manager identification,. (c) or combination of one or more PLMN Manager identification(s):
   Acceptable ranges of deviation for QoS Requirements.
   Acceptable ranges of deviation for Alternative QoS Requirements.
   PDU Session Release Threshold due to QoS Degradation.
   PDU Session Retry Back off timer.

Furthermore, the MPQ Agreement (or Configuration) information can be used for the determination of the parameters (or information, or values of the parameters, or values of the information, or type of) Enforcement Strategy and/or Distribution Strategy can be further determined (or configured) as per any of the following:
For a given inter-PLMN identification (e.g., PLMN ID) having the role of C-PLMN (e.g., there is a PLMN Manager in the PLMND ID with the C-PLMN role associated), use a given Enforcement Strategy and/or Distribution Strategy.
For a given intra-PLMN identification (e.g., Group ID) having the role of C-PLMN (e.g., there is a PLMN Manager in the Group ID with the C-PLMN role associated), use a given Enforcement Strategy and/or Distribution Strategy.
For a given inter and intra-PLMN identification (e.g., PLMN ID and Group ID) having the role of C-PLMN (e.g., there is a PLMN Manager in the PLMN ID and Group ID with the C-PLMN role associated), use a given Enforcement Strategy and/or Distribution Strategy.
For a given application identification use a given Enforcement Strategy and/or Distribution Strategy.

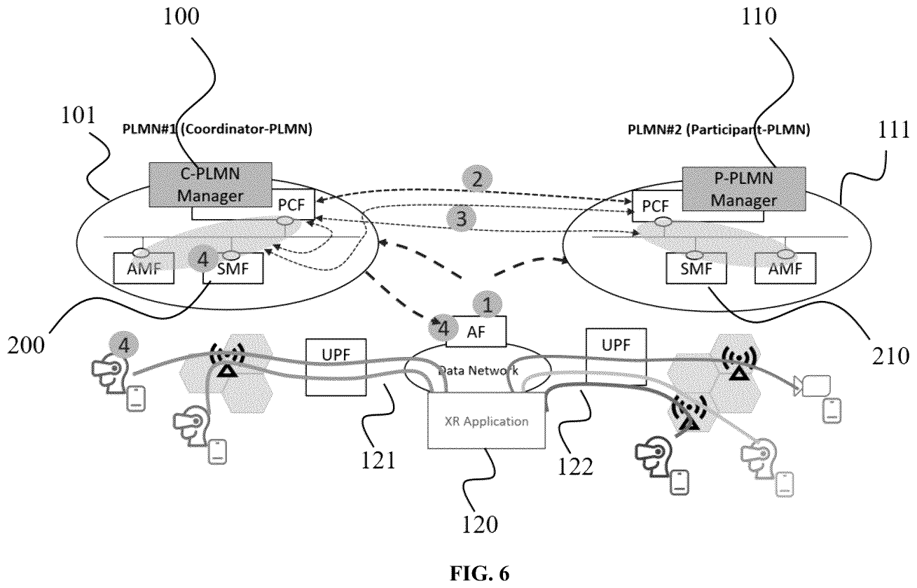

FIG. 6 illustrates an exemplary embodiment of this disclosure considering the Multi-PLMN scenario with two different PLMNs. There is an application with users interacting in the same application scope (e.g., VE), but these users belong to the PLMN #1 and PLMN #2. Additionally, FIG. 6 shows the overall steps that need to be executed in order to enable the establishment and enforcement of MPQ Policy for the QoS Flows of the users depicted in FIG. 6.

Step 1 relates to the process of dissemination of information from AF to PLMN Managers, determination of the PLMN Manager roles and the establishment of the MPQ Policy in each of the PLMN Manger. It is therefore, related to Feature 1 of the disclosure. In this disclosure, at least two different alternatives of embodiments are identified for achieving the dissemination of the information to create the MPQ Policy in the PLMN Managers. These are the possible options of embodiments:
Option 1: SLA-Based.
Option 2: AF-Based
Option 3: SLA-AF Hybrid

Step 2 relates to the process of C-PLMN Manager interacting with P-PLMNs Managers to align (or agree on, or configure, or coordinate) the MPQ Policy parameters of the following MPQ Policy Sections related to Overall information and/or related to Agreements. This step therefore is related to Feature 2 of this disclosure on MPQ Policy Agreement and Distribution and specifically related to how PLMN Managers behave with the different possible values for the “Distribution Strategy” defined in the MPQ Policy. There are at least three alternatives of embodiments in this case:
Option 1: SLA Based (e.g., Distribution Strategy parameter is set to, or is configured with “SLA-Based”)
Option 2: Harmonization of MPQ Parameters (e.g., Distribution Strategy parameter is set to, or is configured with “Harmonization”)
Option 3: Synchronized Best-Effort (e.g., Distribution Strategy parameter is set to, or is configured with “Best-Effort”)

Step 3 relates to the process of C-PLMN Manager interacting with P-PLMNs Managers and/or with SM entities of Multi-PLMN to enforce (or repair, or handle, or manage, or maintain) the QoS fulfillment for the QoS Flows associated with the MPQ Policy. This step therefore is related to Feature 3 of this disclosure on MPQ Policy Changes in case of QoS Fulfillment Failure and specifically related to how PLMN Managers behave with the different possible values for the “Enforcement Strategy” defined in the MPQ Policy. There are at least three alternatives of embodiments in this case:
Option 1: No QOS fulfillment alignment (e.g., Enforcement Strategy parameter is set to, or is configured with “No Alignment”)
Option 2: C-PLMN Manager leading QoS fulfillment alignment (e.g., Enforcement Strategy parameter is set to, or is configured with “C-PLMN Manager Lead alignment”)
Option 3: Any PLMN leading fulfillment alignment (e.g., Enforcement Strategy parameter is set to, or is configured with “Any PLMN Manager Lead alignment”)

Step 4 relates to the process when a QoS fulfillment failure occurs and either the C-PLMN Manager (i.e., PCF of C-PLMN in the case of the C-PLMN Leading option) or any PLMN Manager (i.e., when any PLMN Manager can take the lead to trigger changes in other PLMNs) cannot find a new set of QoS Requirements within the acceptable ranges of the MPQ Policy, such PLMN Manager (i.e., PCF) will:
Trigger the PDU Session Release procedure at the SMF in the Multi-PLMN where the Qos Fulfillment failed (e.g., SM Entities of Multi-PLMN) with PDU Session Retry Back off timer activate.
Notify AF that for a given UE in the given area where such UE is located, the UE was put in “freeze mode” until network conditions improve. Such information can help AF to also temporarily “freeze” the UE in the application (e.g., XR application) without completely disconnecting it, but also not creating bad situations leading other users interacting in the same application (e.g., creating cyber sickness to other users of sharing the same VE of an XR application).

### Embodiments for Feature 1—Multi-PLMN QoS (MPQ) Policy Establishment

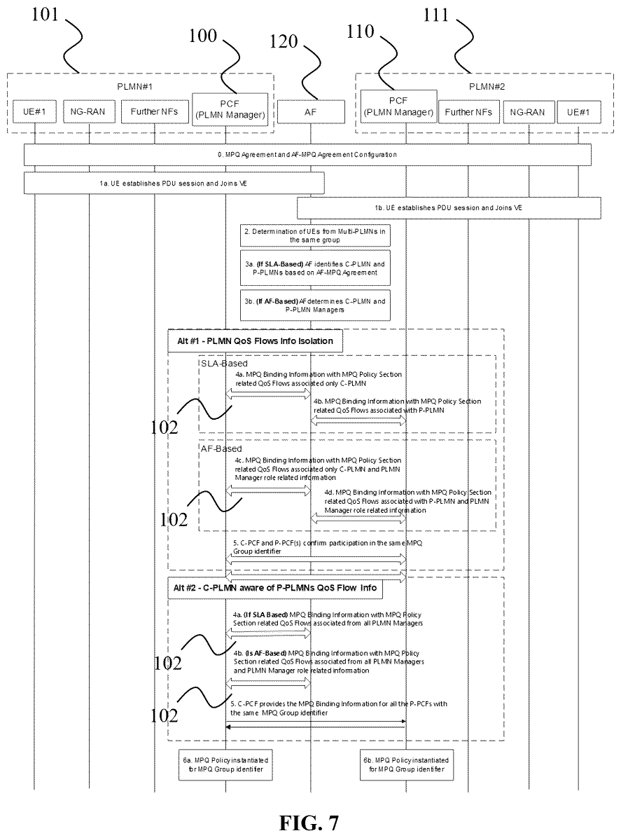

FIG. 7 depicts the procedure for the MPQ Policy Establishment with a possible embodiment for Feature 1. There are 5 steps that need to be performed. For steps 3 and 4 there are for each different alternatives of embodiments that are both described as follows and detailed in the text. The illustration and description of FIG. 7 focus on the multi-PLMN scenario where there are 2 PLMNs serving the UEs interacting in the same application related to AF. The same principles described in FIG. 7 are applicable to the cases described in FIG. 4 and FIG. 5.
0. This step with the whole configuration of MPQ Agreement and AF-MPQ Agreement is only executed in the case of determination of the PCFs (e.g., PLMN Manager) with the C-PLMN and P-PLMNs roles SLA-Based Alternative.

It is also possible that in Step 0, parts of the information on the MPQ Agreement associated with the MPQ Policy Section related to Agreements can be configured at the PCFs.

Examples of parts of MPQ Configuration information that can be configured at the PCFs are any of the following: Acceptable ranges of deviation for QoS Requirements, Acceptable ranges of deviation for Alternative QoS Requirements, PDU Session Release Threshold due to QoS Degradation, PDU Session Retry Back off timer, Enforcement Strategy, Policy Distribution Strategy.
1. (1a and 1b) The UEs establish PDU sessions in the different Multi-PLMNs and AF becomes aware of the existence of such PDU sessions.
2. AF identifies or determines the set of UEs and/or QoS Flows that are belonging to different PLMNs and/or different intra-PLMN regions and interacting together in the same application scope (or application space, or application virtual room, or application environment, or application virtual environment). For instance, the AF has the configuration of the address range of each PLMN or PLMN region. When a QoS Flow is established by the UE, the AF becomes aware of the address of such a flow and it is able then to map the QoS Flow (or Flow Descriptor, or Flow Description) identification to a certain PLMN ID or to the identification of an intra-PLMN scenario (e.g., Group ID or Intra-PLMN region ID).
3. This step is related to the PLMN Manager roles determination between C-PLMN and P-PLMN roles. There is a determination of which roles are assumed by the PCFs in multi-PLMNs associated with (or serving, or managing) the QoS Flows of the multiple UEs (at least 2 different UEs with each 1 QoS Flow) in the same application scope. Nonetheless, the same mechanism can be applicable for the same UE associated with multiple flows, where at least 2 flows of the same UE are being served by different PLMN Managers.
   3a. SLA-Based option for determination of C-PLMN and P-PLMN Manager Roles. In this case, the AF uses the AF-MPQ Agreement information to identify such roles. Details of the SLA-Based determination of C-PLMN and P-PLMN are described later in the text.
   3b. AF-Based option for determination of C-PLMN and P-PLMN Manager Roles. In this case, the AF is the entity responsible to determine based on its internal logic the roles assumed by PCFs (e.g., PLMN Managers) associated with the UE(s) (or QoS Flows or Flow Description, or Flow Descriptor from UE(s)) for a given application associated with a multi-PLMN scenario. Details of the AF-Based determination of C-PLMN and P-PLMN are described later in the text.

Notably, the steps 4 and 5 are executed for distributing the MPQ Binding information 102 among the PCFs of the multi-PLMN.

Once the AF determined the C-PLMN and P-PLMN roles for the involved PCFs in serving the multiple users interacting within the same application scope in a multi-PLMN scenario. In this disclosure two alternatives for AF to provide the MPQ Binding information 102 to one or more PCFs are defined.
6. (6a and 6b) After the C-PCF and the P-PCFs received the MPQ Binding information 102 (either from AF or from the C-PCF), the involved PCFs in the MPQ Group Identification instantiate (or create, or configure) a MPQ Policy based on the MPQ Binding Information 102 (from AF), or based on the updated MPQ Binding Information 102 (in the case of P-PCFs), and/or based on MPQ Configuration information. The instantiated MPQ Policy information is configured with (or have the values set for, or is parametrized with) the information associated with (or related to, or referent to, or point to) the MPQ Policy Section related to QoS Flows and the MPQ Policy related to Overall information.

### The Alternative #1 (Alt #1—PLMN QoS Flow Info Isolation in FIG. 7) is Characterized by the QoS Flow Information Isolation Among the CP Entities of the Multi-PLMN.

4. In this case, AF provides the MPQ information to C-PCF (e.g., C-PLMN Manager role assigned to a PCF) and to one or more P-PCFs (e.g., P-PLMN Manager role to a PCF). The main point is that the MPQ Policy Section related to QoS Flows provided to each PCF (C-PCF and P-PCF(s)) comprises the QoS Flow information related only to the PCF that they are related to (or serving, or managing, or related to).

Additionally depending on the type of PLMN Manager role determination configured in the AF, the MPQ information to be provided to the C and P-PCFs may change.

For any of the cases, the AF is capable of generating a MPQ Group Identification (or Identifier) to be associated with QOS Flows and/or Flow Descriptions and/or Flow Descriptors related to the UE(s) and the application, and finally with the CP-entities of multiple-PLMNs that are serving the QoS Flows.

### Considering SLA-Based PLMN Manager Role Determination

4a. In this case, AF provides the MPQ binding information 102 to the C-PCF comprising any of the following:
   MPQ Group Identification
   List of (or mapping of, or one or more, or set of) C-PCF and P-PCF(s) identification and/or reference point (e.g., an address that allows a consumer of the PLMN Manager to request or invoke its services) associated with the same MPQ Group identifier;
   List of (or set of, or one or more of, or mapping of, or table of, or tuple with) QoS Flow information associated with (or bind to, or belonging to, or served by) the PCF identification (e.g., C-PCF);
   Application identification (e.g., Application ID).
   AF identification and/or reference point.
   Flow Description (or Flow Descriptor).
   QoS requirements for Flow Description (or Flow Descriptor).
   Alternative QoS Requirements for Flow Description (or Flow Descriptor).
   (Optional) PDU Session Release Threshold due to QoS Degradation.
   (Optional) PDU Session Retry Back off timer.
   Acceptable ranges of deviation for QOS Requirements and/or for Alternative QoS Requirements
4b. In this case, AF provides the MPQ binding information 102 to the one or more P-PCF(s) comprising any of the following:
   MPQ Group Identification.
   List of (or mapping of, or one or more, or set of) C-PCF and P-PCF(s) identification and/or reference point (e.g., an address that allows a consumer of the PLMN Manager to request or invoke its services) associated with the same MPQ Group identifier.
   For the PCF identification, any of the following:
      List of (or set of, or one or more of, or mapping of, or table of, or tuple with) QoS Flow information associated with (or bind to, or belonging to, or served by) the PCF identification (e.g., P-PCF);
      List of UE identification associated with the MPQ Policy
      List of QoS Flow identification and/or Flow Description associated with a UE identification.
   Application identification (e.g., Application ID).
   AF identification and/or reference point.
   Flow Description (or Flow Descriptor).
   QoS requirements for Flow Description (or Flow Descriptor).
   Alternative QoS Requirements for Flow Description (or Flow Descriptor).
   (Optional) PDU Session Release Threshold due to QoS Degradation.
   (Optional) PDU Session Retry Back off timer.
   Acceptable ranges of deviation for QoS Requirements and/or for Alternative QoS Requirements

### Considering AF-Based PLMN Manager Role Determination

4c. In this case, AF provides the MPQ binding information 102 to the C-PCF comprising the same parameters described in 4a and additionally it includes the following parameter:
   The list of PCF identifications and their associated C-PLMN or P-PLMN Manager role (or capability, or functionality).
4d. In this case, AF provides the MPQ binding information 102 to the one or more P-PCF comprising the same parameters described in 4b and additionally it includes the following parameter:
   The list of PCF identifications and their associated C-PLMN or P-PLMN Manager role (or capability, or functionality).
5. The C-PCF and P-PCF interact in order to confirm that they all received a MPQ binding information 102 from the AF with a given MPQ Group Identification. There are possible different alternatives of interactions among the PCFs and they are described later in the text.

### The Alternative #2 (Alt #2—C-PLMN Aware of P-PLMN(s) Flow Info in FIG. 7) is Characterized by the QoS Flow Information From All Participating PCFs to be Known by (or Visible to) the C-PCF

4. In this case, AF provides the MPQ information to C-PCF (e.g., C-PLMN Manager role assigned to a PCF) and C-PCF further provides the MPQ Binding information 102 to one or more P-PCFs (e.g., P-PLMN Manager role to a PCF).

### Considering SLA-Based PLMN Manager Role Determination

4a. In this case, AF provides the MPQ binding information 102 to the C-PCF comprising any of the following:
   MPQ Group Identification.
   List of (or mapping of, or one or more, or set of) C-PCF and P-PCF(s) identification and/or reference point (e.g., an address that allows a consumer of the PLMN Manager to request or invoke its services) associated with the same MPQ Group identifier.
   Per PCF identification, any of the following:
      List of (or set of, or one or more of, or mapping of, or table of, or tuple with) QoS Flow information associated with (or bind to, or belonging to, or served by) with such PCF identification.
      List of UE identification associated with the MPQ Policy
      List of QoS Flow identification and/or Flow Description associated with a UE identification.
   Application identification (e.g., Application ID).
   AF identification and/or reference point.
   Flow Description (or Flow Descriptor).
   QoS requirements for Flow Description (or Flow Descriptor).
   Alternative QoS Requirements for Flow Description (or Flow Descriptor).
   (Optional) PDU Session Release Threshold due to QoS Degradation.
   (Optional) PDU Session Retry Back off timer.
   Acceptable ranges of deviation for QOS Requirements and/or for Alternative QoS Requirements.

### Considering AF-Based PLMN Manager Role Determination

4b. In this case, AF provides the MPQ binding information 102 to the C-PCF comprising the same parameters described in 4a and additionally it includes the following parameter:
   The list of PCF identifications and their associated C-PLMN or P-PLMN Manager role (or capability, or functionality).
5. The C-PCF identifies the P-PCFs and provides to the one or more P-PCFs the updated version of the MPQ binding information 102 removing the entire list of QoS Flows associated with the MPQ Group Identification (or Identifier) and instead including: only the list of QoS Flows associated with each P-PCF;

### Details of Embodiment for Determination of PLMN Manager Roles With SLA-Based Approach (Feature 1—Option 1)

Mobile Operators (e.g., PLMNs) establish agreements (e.g., there are Roaming agreements among operators, or Operator's SLA Agreements) among them, and the information from such agreement can be extended to include information related to MPQ Policies among each other.

In this embodiment it is proposes that the Mobile Operators extend (or create a new Agreement) related to the Multi-PLMN QoS Policy. Such MPQ agreement is configured in the PLMN Manager of the Multi-PLMNs or it can be provided to a PLMN Manager by the management entity of such Multi-PLMN. When the MPQ Agreement is configured in the PLMN Manager (e.g., as a script inside the PLMN Manager itself or if it was downloaded from management entity), the MPQ Agreement is also called MPQ Configuration.

The PLMN Manager(s) determine the C-PLMN and P-PLMN roles via configuration when SLA-Based option is used. The determination of the C-PLMN and P-PLMN roles when using the MPQ Agreement can be related to the combination of the Application related information with the inter-PLMN or intra-PLMN related information. For instance, the MPQ Agreement can determine the C-PLMN and P-PLMN roles in any of the following:
For each Application Identification, the C-PLMN role is associated with PLMN Manager Identification of one specific Multi-PLMN identification, and the other PLMN Managers are assigned with the P-PLMN Manager Role.
For a given Application Identification, the C-PLMN Manager role is associated with any. PLMN Manager of a PLMN ID (e.g., the C-PLMN Manager role for a given application is associated with a given PLMN ID).
For a given Application Identification, the C-PLMN Manager role is associated with any PLMN Manager of an intra-PLMN identification (e.g., the C-PLMN Manager role for a given application is associated with a given Group ID or Intra-Region ID).
For a given Application Identification, the C-PLMN Manager role is associated with any PLMN Manager of an PLMN ID with a given intra-PLMN identification (e.g., the C-PLMN Manager role for a given application is associated with a PLMN ID and with a given Group ID or Intra-Region ID).
A PLMN Manager with a given PLMN ID will always be assigned with a C-PLMN Manager role for any application related information.
A PLMN Manager with a given Intra-PLMN identification will always be assigned with C-PLMN Manager role.
A PLMN Manager with a given Inter-PLMN identification and a given Intra-PLMN identification will always be assigned with C-PLMN Manager role.
When a combination of inter-PLMNs identifications is associated with a MPQ Policy (e.g., different PLMN IDs are associated with the same MPQ Policy) a PLMN Manager of a given PLMN ID will take the C-PLMN role, while the other PLMN Managers of the other PLMN IDs will take the P-PLMN Manager roles.
When a combination of intra-PLMNs identifications is associated with a MPQ Policy (e.g., different intra-PLMN identification are associated with the same MPQ Policy) a PLMN Manager with a given PLMN Manager identification associated with the intra-PLMN identification will take the C-PLMN role, while the other PLMN Managers associated with other intra-PLMN identifications will take the P-PLMN Manager roles.
When a combination of intra-PLMNs identifications is associated with a MPQ Policy (e.g., different intra-PLMN identification are associated with the same MPQ Policy) and inter-PLMNs identifications associated with the MPQ Policy, a PLMN Manager with a given PLMN Manager identification associated with a given inter-PLMN identification and with a given intra-PLMN identification will take the C-PLMN role, while the other PLMN Managers will take the P-PLMN Manager roles.

In an SLA-Based determination of C-PLMN and P-PLMN managers, the AF is also aware of which roles can be taken by different inter-PLMN and/or intra-PLMN Managers. In this case, the AF determines the C-PLMN and P-PLMN roles also based on configuration. The AF is configured with a subset of the MPQ Configuration (aka, AF-MPQ Configuration):
For each Application Identification, the C-PLMN role is associated with PLMN Manager Identification of one specific Multi-PLMN identification, and the other PLMN Managers are assigned with the P-PLMN Manager Role.
For a given Application Identification, the C-PLMN Manager role is associated with any PLMN Manager of a PLMN ID (e.g., the C-PLMN Manager role for a given application is associated with a given PLMN ID).
For a given Application Identification, the C-PLMN Manager role is associated with any PLMN Manager of an intra-PLMN identification (e.g., the C-PLMN Manager role for a given application is associated with a given Group ID or Intra-Region ID).
For a given Application Identification, the C-PLMN Manager role is associated with any PLMN Manager of an PLMN ID with a given intra-PLMN identification (e.g., the C-PLMN Manager role for a given application is associated with a PLMN ID and with a given Group ID or Intra-Region ID).
A PLMN Manager with a given PLMN ID will always be assigned with a C-PLMN Manager role for any application related information.
A PLMN Manager with a given Intra-PLMN identification will always be assigned with C-PLMN Manager role.
A PLMN Manager with a given Inter-PLMN identification and a given Intra-PLMN identification will always be assigned with C-PLMN Manager role.
When a combination of (or one or more) inter-PLMNs identifications is associated with a MPQ Group Identification (or Identifier) (e.g., different PLMN IDs are associated with the same MPQ Group Identification (or Identifier)) a PLMN Manager of a given PLMN ID will take the C-PLMN role, while the other PLMN Managers of the other PLMN IDs will take the P-PLMN Manager roles.
When a combination of (or one or more) intra-PLMNs identifications is associated with a MPQ Group Identification (or Identifier) (e.g., different intra-PLMN identification are associated with the same MPQ group identification) a PLMN Manager with a given PLMN Manager identification associated with the intra-PLMN identification will take the C-PLMN role, while the other PLMN Managers associated with other intra-PLMN identifications will take the P-PLMN Manager roles.
When a combination of intra-PLMNs identifications is associated with a MPQ Group Identification (or Identifier) (e.g., different intra-PLMN identification are associated with the same MPQ Group Identification (or Identifier)) and inter-PLMNs identifications associated with the MPQ Policy, a PLMN Manager with a given PLMN Manager identification associated with a given inter-PLMN identification and with a given intra-PLMN identification will take the C-PLMN role, while the other PLMN Managers will take the P-PLMN Manager roles.
When a combination of intra-PLMNs identifications is associated with a MPQ Group Identification (or Identifier) (e.g., different intra-PLMN identification are associated with the same MPQ Group Identification (or Identifier)) and inter-PLMNs identifications associated with the MPQ Policy, a PLMN Manager with a given PLMN Manager identification associated with a given inter-PLMN identification and with a given intra-PLMN identification will take the C-PLMN role, while the other PLMN Managers will take the P-PLMN Manager roles.

### Details of Embodiment for Determination of PLMN Manager Roles With AF-Based Approach (Feature 1—Option 2)

In this alternative the AF is capable to determine the C-PLMN and P-PLMN Manager roles for the PCFs associated with the MPQ Group Identifier (or identification).

Below some examples of how AF can determine C-PLMNs based on any of the following criteria:
C-PLMN Manager is associated with the CP entity of Multiple-PLMN that has the most amount of QoS Flows and/or UEs associated together in the same MPQ Group Identifier (e.g., the most amount of UEs from an application, where such users are interacting among each other in the application scope but are being physically served by different CP entities of Multi-PLMN).
C-PLMN Manager is associated with the CP entity of Multiple-PLMN that has the least amount of users in the same MPQ Group Identifier.
C-PLMN Manager is associated with the CP entity of Multiple-PLMN that has the most amount of QoS Flows (or Flows Description or Flow Descriptor) associated to the same MPQ Group Identifier.
C-PLMN Manager is associated with the CP entity of Multiple-PLMN that has the least amount of QoS Flows (or Flows Description or Flow Descriptor) associated to the same MPQ Group Identifier.
C-PLMN Manager is associated with the CP entity of Multiple-PLMN with better ratio of maintaining requested QoS Requirements. This can be calculated by the AF, based on the frequency that it receives notifications from the PCFs of the multi-PLMNs with the event “QoS targets can no longer (or can again) be fulfilled” as defined in TS 23.503 Clause 6.1.3.18.

### Details of Embodiment for 5G Services Extensions related to Feature 1

AF-PCF interactions or PCF-PCF interactions for provisioning of MPQ Binding Information 102 (Step 4 and 5): There are possible different alternatives of interactions among the AF and PCFs for the provisioning of the MPQ Binding information 102. Examples of services in 5GS that can be used for such interaction are listed below:
Via extension of existing PCF Npcf_PolicyAuthorization service: As in this disclosure the AF is trusted by the mobile operators participating in the same MPQ Group Identifier or in the same MPQ Policy, the 5G service exposed by PCF Npcf_PolicyAuthorization service is directly used by AFs to provide the AF session information. This service can also be invoked by other PCFs to provide the MPQ binding information 102.
   The service operations Npcf_PolicyAuthorization_Create_request and Npcf_PolicyAuthorization_Update_request input parameters are extended with the MPQ Binding Information 102.
Definition of a new service Npcf_MPQPolicyControl including the Create service operation, where the main information is the MPQ Binding Information 102. Service operations to update, delete would also be defined.

PCFs interactions for Confirmation of Same Group participation: There are possible different alternatives of interactions among the PCFs for the confirmation of participation in the same MPQ Group Identification. One possible alternative is using the event exposure service exposed by PCF.

For any event based implementation of the confirmation of joining the same MPQ Group Identifier (the term identifier or identification are used as synonyms), there will be the extension of the Events that can be exposed by PCF defined in TS 23.503 Table 6.1.3.18-1. For instance, PCF can expose the MPQ Policy Establishment event, where other PCFs can subscribe to this event type (event ID=“MPQ Policy Establishment”) using as possible parameters in the event subscription any of the following: AF identification, PLMN ID, or PCF Group ID, or an intra-PLMN region identification, AF session context identification; any AF identification, any PLMN ID, any PCG Group, any intra-PLMN region identification; any AF session context identification; MPQ Group Identification; any MPQ Group Identification; MPQ Policy identification; any MPQ Policy identification.

The notification generated by PCF for the event ID=“MPQ Policy Establishment” can include any of the following information: the MPQ Group Identification, MPQ Policy identification, MPQ Policy identification with a status (e.g., established, changed, deleted); MPQ Group Identification with a status (e.g., established, changed, deleted).

### Embodiments for Feature 2—MPQ Policy Agreement and Distribution

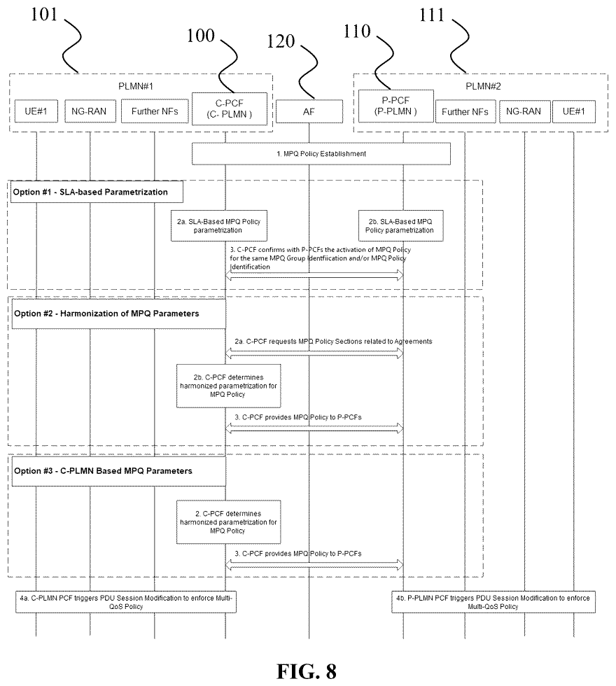

FIG. 8 depicts the exemplary embodiment for the MPQ Agreement and Distribution among the PCFs with C-PLMN and P-PLMN Manager roles related to (or participating, or bind, or configured with, or associated with) the same MPQ Group Identification. There are three different alternatives for the embodiment of the agreement and distribution of the MPQ Policy among the PCFs. These alternatives are related to the setting (or configuration, or values for) the Distribution Strategy to be associated with the MPQ Policy established for the MPQ group Identifier in Step 1 of FIG. 8 (e.g., Step 1 represent the steps necessary to be executed in FIG. 7 to reach the instantiation of a MPQ Policy). These alternatives are:
Alternative #1—SLA-Based Parametrization
Alternative #2—Harmonization of MPQ Parametrization.
Alternnative #3—C-PLMN Based Parametrization

Each one of the alternatives and their respective steps are described as follows. The Steps 1 and 4 (4a and 4b) are common to all the alternatives for MPQ Policy Agreement and Distribution.
1. C-PCF and the P-PCFs instantiate (or create, or configure) a MPQ Policy for a MPQ Group identification and/or for a MPQ Policy identification and the involved PCFs that confirmed (or were notified) of belonging (or being associated to) the same MPQ Group identification and/or MPQ Policy identification.

NOTE: Steps 2 and 3 are executed according to the Distribution Strategy used for the MPQ Policy and are described later in the text.

At the end of execution of Step 3, all PCFs related to the same MPQ Group identification and/or for a MPQ Policy identification have the complete parametrization of the MPQ Policy information and can apply the configuration (or the parameters, or the parameter values, of the values of the fields) of the MPQ Policy Section related to Agreement to the associated PDU Sessions of the UE(s) and/or QoS Flows identification and/or QoS Flow Description that are in their turn associated with the MPQ Policy (e.g., the MPQ Policy Section related to QoS Flows).
4. If necessary (e.g., QoS requirements of already established PDU sessions from the UE(s) and/or QoS Flows associated with a MPQ Policy are out of the Acceptable ranges of deviation defined in the MPQ Policy related to Agreements) each PCF will trigger the update of the PDU sessions to align the QoS requirements of the related PDU session to the MPQ Policy.

Each PCF can update their local MPQ Policy information including the one or more PDU session identification(s) related to the MPQ Policy. It is possible the each PCF includes in the MPQ Policy Section related to QoS Flows the mapping of the PDU session identification to QoS flows identification and/or UE(s) and/or Flow Description identification and/or Flow Descriptor identification. Each PCF obtain the PDU Session identification based on the exchange of information with SMF for the SM Policy Association.

For triggering the PDU Session association, the PCF updates the PCC policy parameters associated with the SM Policy of the PDU Session associated with the MPQ Policy.

Additionally, the PCF provides to SMF via the SM Policy Association information, an indication that the PDU session identification is related to a MPQ Policy. Examples of the indication are any of the following: the MPQ Policy identification (local or global MPQ Policy identification), the MPQ Group Identification, a flag setting the PDU session as MPQ Policy Enabled.

### Embodiment for Feature 2 Option 1: SLA Based Parametrization

2. (2a and 2b in FIG. 6) After step 1, each PCF (C-PLMN and P-PLMN) has determined the strategy agreement and distribution of MPQ Policy parametrization for interacting with other PCFs of the same MPQ Group identification and/or related to the same MPQ Policy identification (e.g., Global MPQ Policy Identification).

In this embodiment the determination is based on the MPQ Agreement (or Configuration) information (or value, or information) set for or configured for the Distribution Strategy field (or parameter). Alternatives of determinations were described in Section 4.5.2.

The SLA among the mobile operators is the same in the MPQ Agreement in each PCF. Therefore, each PCF (C-PCF and P-PCF(s)) identifies that SLA-based Policy Distribution is to be used.

Each PCF updates the information (or parameters) of an established (or instantiated, or configured, or deployed) MPQ Policy information related to the MPQ Group identification and/or related to a MPQ Policy identification with the information of the MPQ Policy Section related to Agreements from the MPQ Configuration matching the C-PLMN Manager role and/or application criteria.
3. As depicted in FIG. 8, C-PCF interacts with P-PCFs associated with the same MPQ Group Identification and/or MPQ Policy Identification. C-PCF obtains an indication from all P-PCFs that they also updated their local MPQ Policy information related to Agreements, based on the MPQ Policy Section related to Agreement associated with the MPQ Agreement information (e.g., that is known to all the involved PCFs). Examples of indications are any of the following:
A tuple with the MPQ Agreement identification and a status (updated, or changed as per SLA, or configuration completed, or establishment completed) that is provided as output parameters when the C-PCF sends a request for confirmation of MPQ parametrization to the P-PCFs (e.g., reusing and extending the Npcf_Policy Authorization service operations).
An event that is produced by each PCF associated with the same MPQ same MPQ Group Identification and/or MPQ Policy Identification. Each PCF can expose a “MPQ Policy Configuration Complete” event type, where the subscription parameters comprise any of the following: AF identification, PLMN ID, or PCF Group ID, or an intra-PLMN region identification, AF session context identification; any AF identification, any PLMN ID, any PCG Group, any intra-PLMN region identification; any AF session context identification; MPQ Group Identification; any MPQ Group Identification; MPQ Policy identification; any MPQ Policy identification;

### Embodiment for Feature 2 Option 2: Harmonized Parametrization

2. (2a in Option #2 of FIG. 8) After step 1, each PCF (C-PLMN and P-PLMN) has an instantiated MPQ Policy that is not completely configured yet. The PCFs need to further determine the one or more parameters (or fields, or information) of the MPQ Policy related to Agreements, so that all involved PCFs have the proper information (or values of the parameters, or configuration of the parameters) to decide on the Distribution Strategy and Enforcement Strategy to be used by all PCFs, as well as any of the following parameters: the acceptable ranges of deviation of QoS requirements, the acceptable ranges of deviation for Alternative QoS Requirements, PDU Session Release Threshold due to QoS Degradation, and PDU Session Retry Back off timer.

To achieve such alignment among the PCFs associated with the same MPQ Group Identification and/or MPQ Policy identification, the C-PCF sends (or provides) to one or more P-PCFs a request for the local MPQ Policy Section related to Agreements associated with a MPQ Group Identification and/or MPQ Policy identification.

The one or more P-PCFs send to the C-PCF a response with the information (or parameters) of the MPQ Policy Section related to Agreement information and their respective values (e.g., that have been configured at each P-PCF).

(2b in Option #2 of FIG. 8). Based on the one or more information received from the P-PCF(s) the C-PCF determines aligned MPQ Policy Section related to Agreement information, which is a the set of (or one or more) values for the parameters (or information) of the MPQ Policy Section related to agreements that can be used by all PCFs related to the same MPQ Group Identification and/or MPQ Policy identification.

Some examples of how C-PCF determines the aligned MPQ Policy Section related to Agreement information are described as follows:
For parameters (or fields or information) from MPQ Policy Section related to Agreement information that have a numerical value (e.g., Acceptable ranges of deviation, or PDU Session Release Threshold due to QoS Degradation, or PDU Session Retry Back off timer) the C-PCF can use any of the following criteria for determining the numerical value: the average, medium, higher, lower or the parameter with a numerical value.
For parameters (or fields or information) from MPQ Policy Section related to Agreement information that have are an enumeration (e.g., that have a fixed list of possible values that can be used, such as Distribution Policy and Enforcement Policy), the C-PCF can choose to use the most frequent enumeration value.
3. The C-CFP provides to the P-CPFs the aligned MPQ Policy Section related to Agreement information to the P-PCFs and each PCF provides in response to the C-PCF an indication of MPQ Policy parametrization finalization.

### Embodiment for Feature 2 Option 3: C-PLMN Manager Based Parametrization

2. In FIG. 8 Option #3, after step 1, each PCF (C-PLMN and P-PLMN) has an instantiated MPQ Policy that is not completely configured yet. If the C-PCF determines based on its MPQ Configuration that it has to use the “C-PLMN Manager Based Parametrization” option for the MPQ Policy Information distribution among P-PCFs with the same MPQ Group Identification and/or MPQ Policy identification, the C-PCF determines the parameters (or field values, or parameter values, or information) related to the MPQ Policy Section related to Agreement information that should be used by all the PCFs.

The determination of such information can be based on the MPQ Configuration of the C-PCF.

The C-PCFs determine the one or more parameters (or fields and their associated values, or information, or parameter values) for the MPQ Policy related to Agreement information to be provided to the P-PCFs, so that all involved PCFs have the proper information (or values of the parameters, or configuration of the parameters) to use the same Distribution Strategy and Enforcement Strategy, as well as any of the following parameters: the acceptable ranges of deviation of QOS requirements, the acceptable ranges of deviation for Alternative QoS Requirements, PDU Session Release Threshold due to QoS Degradation, and PDU Session Retry Back off timer.
3. The C-CFP provides to the P-CPFs the determined (or aligned) MPQ Policy Section related to Agreement information to the P-PCFs and each PCF provides in response to the C-PCF an indication of MPQ Policy parametrization finalization.

### Details of Embodiment for 5G Services Extensions related to Feature 2

There are different alternatives to extend PCF services to allow the interaction and exchange of information among the PCFs. Some of these alternatives are described as follows:
Via extension of existing PCF Npcf_PolicyAuthorization service: This service can be invoked by other PCFs to enable the exchange of information for finalizing the MPQ Policy parametrization.

The service operations Npcf_PolicyAuthorization_Create_request and/or Npcf_PolicyAuthorization_Update_request input parameters are extended with: (a) the request for the local MPQ Policy Section related to Agreements and/or (b) the determined (or aligned) MPQ Policy Section related to Agreement information both new parameters associated with a MPQ Group Identification and/or MPQ Policy identification. The output parameters of such service can be extended with (c) local MPQ Policy Section related to Agreement information and/or (d) confirmation of MPQ Policy parametrization finalization
Definition of a new service Npcf_MPQPolicyControl including the Create and Update service operation, where the input and output parameters described above for Npcf_PolicyAuthorization are included. The difference is that the Npcf_PolicyAuthorization is not reused, but a dedicated service only for MPQ related information is used instead.

### Embodiment for Feature 3—MPQ Policy Changes in Case of QoS Fulfillment Failure

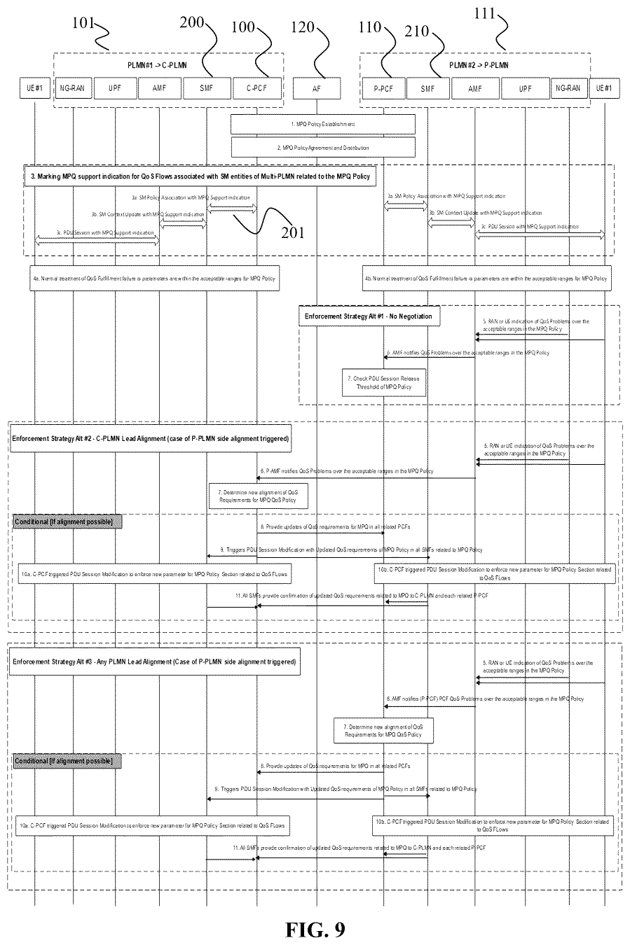

FIG. 9 depicts the exemplary embodiment for the MPQ Policy Changes in case of QoS Fulfillment Failures. There are 3 different alternatives for the embodiments and they are related to the type of enforcement strategy used by the PLMN Managers related to the same MPQ Policy. These alternatives are:
Alternative #1—When Enforcement Strategy is No Negotiation.
Alternative #2—When Enforcement Strategy is C-PLMN Manager Lead Alignment
Alternative #3—When Enforcement Strategy is Any PLMN Manager Lead Alignment

Each one of the alternatives and their respective steps are described as follows. The Steps 1 and 4 (4a and 4b) are common to all the alternatives for MPQ Policy Changes in case of QoS Fulfillment Failures.

Step 3 in FIG. 9 shows the process that occur in parallel in all the PLMNs (or multi-PLMN environments) associated with the same MPQ Policy (e.g., associated with the same MPQG ID and/or MPQP ID).

Each PCF (e.g., PLMN Manager) provides to the SMF (Step 3a in FIG. 9), during the SM Policy Association procedures (establishment or update), the MPQ Support Indication 201. With this information SMF will be configure to accept requests from other PCFs to enforce changes in the PDU sessions and/or QoS Flows associated with a given MPQ Policy.

The MPQ Support information has also to be provided to the AMF (Step 3b in FIG. 9), to allow the AMF to directly communicate with a different PCF (e.g., C-PLMN if required) to provide the QoS Problem notification when there is a failure in providing QoS requirements to the flows within the acceptable ranges of deviations configured in the MPQ Policy.

Optionally the MPQ Support indication 201 can also be provided to the RAN node and/or to the UE (Step 3c in FIG. 9) associated with the MPQ Policy. This can be implemented extending the information in the N1 and N2 containers that are sent from AMF to the RAN and UE entities. With the MPQ Support indication 201, RAN and/or UE(s) can identify that the QoS non-fulfillment that is being experience is crossing the thresholds related to MPQ Policy, and with this, RAN and/or UE (Step 5 in all alternatives depicted in FIG. 7). This can support AMF to decide not to trigger an SM Context Update or notify the local PCF about QoS problems, but instead, the AMF would be aware that such QoS non-fulfillment information from RAN and/or UE is related to a MPQ Policy and could start the mechanisms for handling the QoS non-fulfillment according with the enforcement strategy defined for the associated MPQ Policy.

### Embodiment for Feature 3 Alternative 1: No Alignment

In this exemplary embodiment if any PCF operating with a MPQ policy for the QoS Flows of controlled UE(s) (e.g., UE(s) being served by the PCF), upon receiving a QoS Problem Notification from AMF (e.g., SM Entity of Multi-PLMN), is not able to find a set of QoS requirements within the acceptable range defined for the MPQ Policy, the only alternative such PCF (e.g., PLMN Manager) has it to evaluate the possibility of triggering the mechanisms for triggering the freezing of the PDU session associated with the notifications of QoS non fulfillment out of the acceptable ranges related to the MPQ Policy

### Embodiment for Feature 3 Alternative 2: C-PLMN Manager Leading QoS Fulfillment Alignment

In this exemplary embodiment, the C-PCF (e.g., C-PLMN Manager) will be the entity responsible for receiving any QoS Problem notification, either from the AMF within its own multi-PLMN environment or from AMF from P-PLMNs (or other multi-PLMN environments).

The AMF defines the C-PCF to interact with (Step 6 in FIG. 9) based on the MPQ Support indication 201 it has stored in previous steps (Step 3 in FIG. 9). The AMF then also identifies if it should interact with its local PCF or with the C-PCF. In this embodiment the AMF determines it needs to interact with the C-PCF and send the QoS Problem Notification to the C-PCF.

This information exchange can be achieved via event based implementation, where the C-PCF during the execution of Step 2 in FIG. 9 subscribes to all AMFs associated with the same MPQ Policy to a new event exposed by such AMFs. The event type would be “MPQ QOS Problem Notification”, where the PCF subscribes using as target of the event reporting the MPQP ID and/or the MPQG ID, and where the notification message related to such event comprises the QoS Problem Notification.

If the C-PCF is able to determine a new acceptable set of QoS requirements for the MPQ Policy related to the received QoS Problem Notification (Step 7 in FIG. 9), the C-PCF updates the MPQ Policy and provide the updated MPQ policy with the other PCFs associated with the same MPQ Policy (Step 8 in FIG. 9). The C-PCF also triggers in all SMFs associated with the MPQ Policy the PDU Session Modification with the new QoS requirements for the QoS Flows associated with the MPQ Policy (Step 9 in FIG. 9).

Each SMF that received the trigger for PDU Session Modification (e.g., if C-PCF sent a SM Policy Association Update), will perform the steps according with TS 23.502 PDU Session Modification procedures to enforce the new QoS parameters for the QoS flows related to the updated MPQ Policy (Step 10 in FIG. 9). In case of successful PDU session modification, the SMF(s) will notify the C-PCF ((Step 11 in FIG. 9)). In case of failure, the SMF releases the PDU session and notifies the C-PCF (and its local PCF) that the PDU session has been released.

### Embodiment for Feature 3 Alternative 3: Any PLMN Leading Fulfillment Alignment

The exemplary embodiment for this option has the same steps as described in the Embodiment for the Option 2 with C-PLMN Manager leading alignment. The difference is that any PCF associated with the MPQ Policy that received the QoS Problem notification information from AMF, can trigger in other multi-PLMN environments the PDU session Modification and update of MPQ Policies.

### Embodiment for Feature 4—Freezing of PDU Session and/or QoS Flows

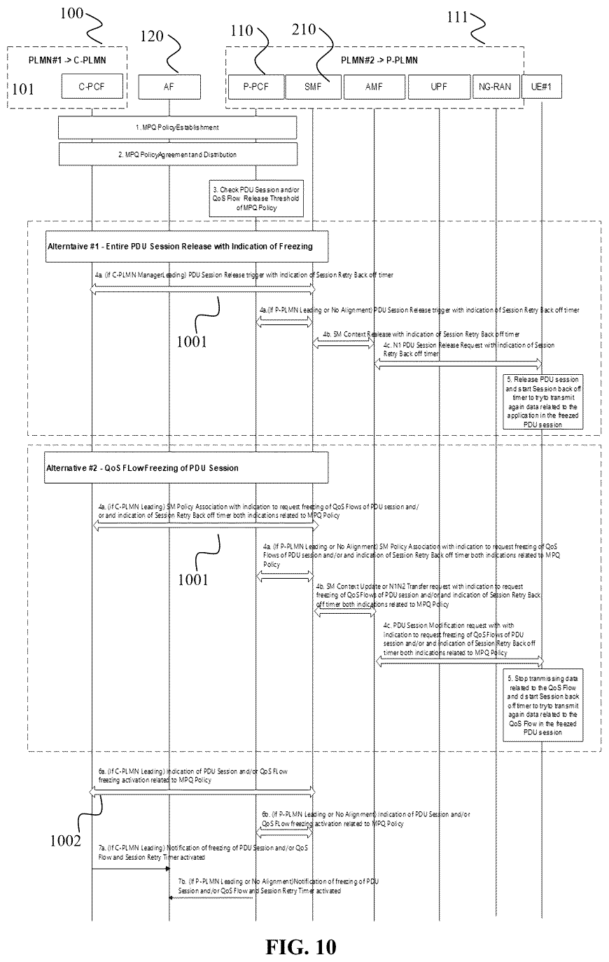

FIG. 10 depicts the embodiment for the Freezing of PDU Session and/or QoS Flows. When a PCF tries and is not successful in finding a new set of QoS Requirements to solve the issue of QoS non-fulfillment for one or more QoS Flows of a PDU session, such PCF use as a new alternative the possibility to freeze the QoS Flow(s) and/or the PDU session that is experiencing (or suffering) the QoS non-fulfillment. There are 2 different alternatives for the embodiments for enabling freezing of resources related to data traffic experiencing QoS non-fulfillment. These alternatives are:
Alternative #1—Entire PDU Session Release with Indication for Freezing.
Alternative #2—QoS Flow Freezing of PDU Session

In Step 3 the PLMN Manager determines that a PDU Freezing should be activated (e.g., when there is no alternative to update the QoS parameters of the MPQ Policy).

In case of Alternative #1, (Step 4) the PLMN Manager provides an indication 1001 to release the PDU Session with the activation of the Session Retry Back off timer to the SMF (e.g., SM Entity of the Multi-PLMN) related to the QoS Flow and/or PDU session associated with a QoS Problem Notification.

In case of Alternative #2, (Step 4) the PLMN Manager provides an indication 1001 to freeze one or more QoS Flows of a PDU Session with the activation of the Session Retry Back off timer to the SMF related to the QoS Flow and/or PDU session associated with a QoS Problem Notification.

In Alternative #1, the indication 1001 provided by the PCF (PLMN Manager) can be part of the PDU Session Release procedure, with PCF providing information to SMF leading to a SM Association termination and PDU Session Release.

In Alternative #2, the indication 1001 provided by the PCF can be part of a SM Association Policy update procedure.

The SMF that received an indication 1001 for release the PDU Session or the indication 1001 to freeze one or more QoS Flows of a PDU Session in both cases with the activation of the Session

Retry Back off timer provides directly or indirectly to the UE associated with such PDU session such Session Retry Back off.

This can be achieved by SMF interacting with AMF to provide a NIN2 transfer to the UE with the information about the indication for one or more QoS Flow freezing. AN example of such indication can be a flag to freeze QoS Flow mapped to a QFI.

The UE uses the Session Retry Back off timer to stop trying to establish new PDU sessions for the same type of the data traffic of the application during the interval of the back of timer or to stop transmitting data traffic related to the frozen QoS Flow(s) during the interval of the back off timer without releasing the PDU Session.

The PLMN Manager obtains from the SM entity of the Multi-PLMN a confirmation 1002 of PDU Session and/or QoS Flow freezing;

The PLMN manager provides to the AF related to the frozen PDU Session and/or QoS Flow(s) an indication of PDU Session and/or QoS Flow(s) freezing activation and/or the used freezing back off timer for such PDU and/or QoS Flow that has been frozen. A possible implementation of such information reaching AF is done using event exposure. The PCF can expose the event types “PDU Session Freeze” and/or “QOS Flow Freezing”; the AF subscribe to PCF event exposure using parameters such as the MPQG ID, and/or the MPQP ID; and/or QoS Flow descriptor identifier; and/or Applications identifier. Once a freezing of PDU session and/or QoS Flow(s) is executed, the PCF will notify the AF with the event containing any of the following information: MPQG ID, and/or the MPQP ID; and/or QoS Flow descriptor identifier; and/or Applications identifier, and/or used backoff timer.

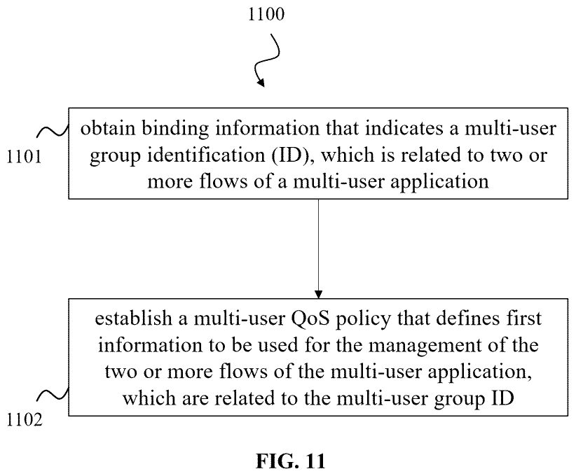

FIG. 11 shows a method 1100 according to this disclosure. The method 1100 is for managing QoS of a first set of one or more flows of a multi-user application 120. The method 1100 is performed by a first control plane entity 110 that is in a first network and/or in a first network region 101, or is in a first group of control plane entities of a network.

The method 1100 comprises obtaining binding information 102 that indicates a multi-user group identification, ID, which is related to two or more flows 121, 122 of the multi-user application 120. At least one of the two or more flows 121 is in the first set of flows managed by the first control plane entity 100, and at least one of the two or more flows 122 is in a second set of flows managed by a second control plane entity 110. The second control plane entity 110 is in a second network and/or in a second network region 111, or is in a second group of control plane entities of the network.

The method 1100 further comprises establishing a multi-user QoS policy 103 that defines first information to be used for the management of the two or more flows 121, 122 of the multi-user application 120, which are related to the multi-user group ID. The multi-user QoS policy (103) is associated with the multi-user group ID and/or a multi-user policy ID.

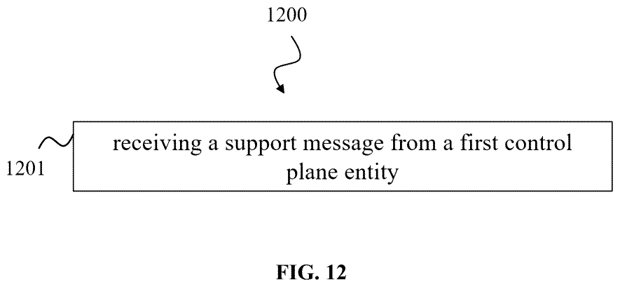

FIG. 12 shows a method according to this disclosure. The method 1200 is for supporting the management of QoS of at least one flow 121 of two or more flows 121, 122 of a multi-user application 120. The method 1200 is performed by a first session management entity 200 that is in a first network and/or in a first network region 101, or is associated with a first group of control plane entities of a network. The two or more flows 121, 122 of the multi-user application 120 are related to a multi-user group ID and/or a multi-user policy ID associated with a multi-user QoS policy 103.

The method 1200 comprises receiving a support message 201 from a first control plane entity 110, wherein the support message 201 includes one or more of:
An ID of the first control plane entity 100, wherein the first control plane entity 100 is in the first network and/or in the first network region 101 or in the first group of control plane entities, and wherein the at least one flow 121 of the two or more flows 121, 122 of the multi-user application 120 is in a first set of flows managed by the first control plane entity 100.
An ID of a second control plane entity 110, wherein the second control plane entity 110 is in a second network and/or in a second network region 111, or is in a second group of control plane entities of the network, and wherein at least one further flow 122 of the two or more flows 121, 122 is in a second set of flows managed by the second control plane entity 110.
An indication that the second control plane entity 110 is in a different network and/or network region 111 than the first session management entity 200.
An address or reference or identification of the second control plane entity 110, wherein the address or reference or identification indicates to the first session management entity 200 that it can obtain session management and/or QoS management control information from the second control plane entity 110 for the at least one flow 121 of the two or more flows 121, 122 of the multi-user application 120 related to the multi-user group ID and/or the multi-user policy ID.
The multi-user group ID and/or the multi-user policy ID.
One or more flow IDs of flows of the multi-user application (120).

This disclosure, for example, provides a PLMN Manager (C-PLMN Manager/first PLMN Manager and/or P-PLMN Manager/Second PLMN Manager) that obtains the Multi PLMN QOS (MPQ) binding information from an AF and/or an updated Multi PLMN QOS (MPQ) binding information and/or parts of the MPQ Binding information from another PLMN Manager (C-PLMN Manager). The PLMN Manager (C-PLMN Manager/first PLMN Manager and/or P-PLMN Manager/Second PLMN Manager) obtains the MPQ Configuration information or parts of the MPQ Configuration information by configuration and/or from a Management Entity. The PLMN manager (C-PLMN Manager/first PLMN Manager and/or P-PLMN Manager/Second PLMN Manager) obtains the MPQ Policy based on the Multi PLMN QOS (MPQ) binding information and/or updated MPQ binding information and/or parts of the and/or MPQ Configurations and/or parts of the MPQ Configuration information, where the MPQ Policy at a PLMN Manager can be further characterized as a local MPQ Policy (comprising MPQ Policy Section related to Multi-PLMN QOS Flow Group Identifier and the MPQ Policy Section related to QoS Flows managed by one PLMN Manager) or a global MPQ Policy (comprising MPQ Policy Section related to Multi-PLMN QOS Flow Group Identifier and the MPQ Policy Section related to QoS Flows managed by one or more PLMN Managers associated with the same Multi-PLMN QOS Flow Group Identifier). The above-described enables alignment of the QoS parameters to be used for QoS flows related to the same XR application (or VE or the same XR application) in a multi-PLMN scenario.

The disclosure, for example, also provides a PLMN Manager provides to one or more SM entities of the multi-PLMN, where the PLMN Manager and the SM Entity of the Multi-PLMN are related, a MPQ Support Indication 102 related to a MPQ Policy 103 (e.g., a list (or set or group or one or more) of PLMN Manager identification(s) and/or reference point (e.g., address) that can control one or more QoS Flows related to the local MPQ Policy related to such SM entity(ies) of multi-PLMN. The above-described leads to a reduction of delay on performing tasks for repairing QoS fulfillment failure of a QoS Flow related to a MPQ Policy.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single clement or other unit may fulfill the functions of several entities or items recited in the claims. The mere fact that certain measures are recited in the mutual different dependent claims does not indicate that a combination of these measures cannot be used in an advantageous implementation.

1. A first control plane entity (100), wherein the first control plane entity (100) is in at least one of a first network or a first network region (101), or is in a first group of control plane entities of a network, and wherein the first control plane entity (100) comprises a processor and a storage medium storing executable software code that, when executed by the processor, cause the first control plane entity (100) to:
obtain binding information (102) that indicates a multi-user group identification (ID) which is related to two or more flows (121, 122) of a multi-user application (120);
wherein at least one of the two or more flows (121, 122) is in a first set of flows managed by the first control plane entity (100), and at least one of the two or more flows (121, 122) is in a second set of flows managed by a second control plane entity (110);
wherein the second control plane entity (110) is in at least one of a second network or a second network region (111), or is in a second group of control plane entities of the network; and
establish a multi-user QoS policy (103) that defines first information to be used for management of the two or more flows (121, 122) of the multi-user application (120), which are related to the multi-user group ID;
wherein the multi-user QoS policy (103) is associated with at least one of the multi-user group ID or a multi-user policy ID.

2. The first control plane entity (100) according to claim 1, wherein the binding information (102) includes at least one of the following:
the multi-user group ID;
flow related information;
application related information;
QoS requirement(s) related information;
information identifying one or more control plane entities (100, 110) associated with the multi-user group ID;
information for accessing the one or more control plane entities (100, 110) associated with the multi-user group ID;
a mapping of one or more flows (121, 122) to one or more control plane entities (100, 110) associated with the multi-user group ID; or
information related to boundaries of QoS requirements to be used by the one or more control plane entities (100, 110) associated with the multi-user group ID.

3. The first control plane entity (100) according to claim 1, wherein the first information defined by the multi-user QoS policy (103) determines at least one of:
one or more parameters, or associated values related to one or more of the following:
one or more control plane entities (100, 110) associated with the multi-user QoS policy (103);
one or more interaction actions among two or more control plane entities (100, 110) associated with the multi-user QoS policy (103);
a mapping of one or more flows (121, 122) to a control plane entity (100, 110) associated with the multi-user QoS policy (103);
one or more QoS requirements associated with the one or more flows (121, 122);
information to reach or to enable the interaction with each of the one or more control plane entities (100, 110) associated with the multi-user QoS policy (103); or
application related information.

4. The first control plane entity (100) according to claim 1, wherein the first control plane entity (100) is caused to receive the binding information (102) from at least one of an application function (AF) (120), the second control plane entity (110), or a third control plane entity.

5. The first control plane entity (100) according to claim 1, wherein the first control plane entity (100) is caused to:
establish the multi-user QoS policy (103) based on at least one of the binding information (102) or multi-user QoS policy configuration information;
wherein the multi-user QoS policy configuration comprises at least one of:
one or more acceptable ranges of deviation for one or more QoS requirements;
one or more acceptable ranges of deviation for one or more alternative QoS requirements;
a QoS degradation threshold for triggering a session release, the session comprising one or more flows (121, 122);
a session retry back off timer;
an enforcement strategy for the multi-user QoS policy (103); or
a policy distribution strategy for the multi-user QoS policy (103).

6. The first control plane entity (100) according to claim 1, wherein the first control plane entity (100) is further caused to determine based on the binding information (102), whether the first control plane entity (100) is a coordinator control plane entity among at least two control plane entities (100, 110) associated with at least one of the same multi-user group ID or multi-user policy ID.

7. The first control plane entity (100) according to claim 6, wherein the first control plane entity (100) is caused to determine whether the first control plane entity (100) is the coordinator control plane entity based on:
the binding information (102) and one or more parameters of a service level agreement (SLA), where the one or more parameters are received from another control plane entity associated with at least one of the multi-user group ID or multi-user policy ID;
the binding information (102) and one or more parameters of a service level agreement (SLA), where the one or more parameters are configured at the first control plane entity (100) associated with at least one of the multi-user group ID or multi-user policy ID; or the binding information (102) and a coordination indication received from an AF related to the multi-user group ID.

8. The first control plane entity (100) according to claim 1, wherein the first control plane entity (100) is further caused to send, to the second control plane entity (110), second information that comprises a request to the second control plane entity (110), to confirm by the second control plane entity (110) that the second control plane entity (110) has also established a multi-user QoS policy associated with at least one of the multi-user group ID or the multi-user policy ID.

9. The first control plane entity (100) according to claim 8, wherein the second information includes information related to the multi-user QoS policy to be used at the second control plane entity (110).

10. The first control plane entity (100) according to claim 1, wherein the first control plane entity (100) is further caused to, upon receiving a confirmation that the second control plane entity (110) has also established a multi-user QoS policy associated with at least one of the multi-user group ID or the multi-user policy ID, associate an ID of the second control plane entity (110) with the multi-user QoS policy (103) established at the first control plane entity (100).

11. The first control plane entity (100) according to claim 1, wherein the first control plane entity (100) is further caused to send, to the second control plane entity (110), third information that indicates to the second control plane entity (110) that the first control plane entity (100) has established the multi-user QoS policy (103) associated with at least one of the multi-user group ID or the multi-user policy ID.

12. A first session management entity (200), wherein the first session management entity (200) is in at least one of a first network or a first network region (101), or is associated with a first group of control plane entities (100) of a network, wherein the two or more flows (121, 122) of the multi-user application (120) are related to at least one of a multi-user group ID or a multi-user policy ID associated with a multi-user QoS policy (103), and wherein the first session management entity (200) comprises a processor and a storage medium storing executable software code that, when executed by the processor, cause the first session management entity (200) to:
receive a support message (201) from a first control plane entity (100), wherein the support message (201) includes one or more of:
an ID of the first control plane entity (100), wherein the first control plane entity (100) is in at least one of the first network or the first network region (101) or in the first group of control plane entities, and wherein at least one flow (121) of two or more flows (121, 122) of a multi-user application (120) is in a first set of flows managed by the first control plane entity (100);
an ID of a second control plane entity (110), wherein the second control plane entity (110) is in at least one of a second network or a second network region (111), or is in a second group of control plane entities of the network, and wherein at least one flow (122) of the two or more flows (121, 122) of the multi-user application (120) is in a second set of flows managed by the second control plane entity (110);
an indication that the second control plane entity (110) is in at least one of a different network or network region than the first session management entity (200);
an address or reference or identification of the second control plane entity (110), wherein the address or reference or identification indicates to the first session management entity (200) that it can obtain at least one of session management or quality of service (Qos) management control information from the second control plane entity (110) for the at least one flow (121) of the two or more flows (121, 122) of the multi-user application (120) related to at least one of the multi-user group ID or the multi-user policy ID;
at least one of the multi-user group ID or the multi-user policy ID; or
one or more flow IDs of flows of the multi-user application (120).

13. The first session management entity (200) according to claim 12, wherein the first session management entity (200) is further caused to determine a multi-user QoS fulfilment status of the multi-user QoS policy (103) related to the at least one flow (121) of the two or more flows (121, 122) related to at least one of the multi-user group ID or the multi-user policy ID, wherein the QoS fulfilment status indicates whether one or more QoS requirements of the multi-user QoS policy (103) are fulfilled or are not fulfilled.

14. The first session management entity (200) according to claim 12, wherein the first session management entity (200) is further caused to:
determine the multi-user QoS fulfillment status based on support information related to at least one of the multi-user group ID or multi-user policy ID received from a second control plane entity (110);
wherein the second control plane entity (110) is in at least one of the second network or second network region (111), or is associated with the second group of control plane entities.

15. The first session management entity (200) according to claim 12, wherein the first session management entity (200) is further caused to send support information related to at least one of the multi-user group ID or multi-user policy ID to one or more other session management entities (210).

16. The first session management entity (200) according to claim 12, wherein the first session management entity (200) is further caused to provide a QoS control information to at least one of the first control plane entity (100) or the second control plane entity (110);
wherein the QoS control information indicates a QoS problem of the at least one flow (121) of the two or more flows (121, 122) of the multi-user application (120); and
wherein the QoS problem is based on an insufficient QoS fulfillment status of the multi-user QoS policy (103) associated with at least one of the multi-user group ID or multi-user policy ID.

17. The first session management entity (200) according to claim 16, wherein the first session management entity (200) is further caused to determine, based on the support information, to which of at least one of the first control plane entity (100) or the second control plane entity (110) to provide the QoS control information.

18. The first session management entity (200) according to claim 16, wherein the first session management entity (200) is further caused to receive, from at least one of the first control plane entity (100) or the second control plane entity (110), a freezing indication (1001) that is related to a QoS problem indicated by the QoS control information.

19. The first session management entity (200) according to claim 16, wherein the first session management entity (200) is further caused to:
provide a first freezing notification (1002) to the second control plane entity (110), the first freezing notification (1002) indicating that all one or more flows (121) of a session related to the first set of flows of the multi-user application associated with at least one of the multi-user group ID or the multi-user policy ID or a single flow of a session including multiple flows (121) related to the first set of flows of the multi-user application (120) associated with at least one of the multi-user group ID or the multi-user policy ID has been frozen; or
provide a second freezing notification to the first control plane entity (100), the second freezing notification indicating that a single flow (121) of a session including multiple flows (121) of the first set of flows related to the multi-user application (120) associated with at least one of the multi-user group ID or the multi-user policy ID has been frozen.

20. A method (1100) for managing quality of service (QOS) of a first set of one or more flows of a multi-user application (120), wherein the method (1100) is performed by a first control plane entity (110) that is in at least one of a first network or a first network region (101), or is in a first group of control plane entities of a network, and wherein the method (1100) comprises:
obtaining (1101) binding information (102) that indicates a multi-user group identification (ID) which is related to two or more flows (121, 122) of the multi-user application (120);
wherein at least one of the two or more flows (121, 122) is in the first set of flows managed by the first control plane entity (100), and at least one of the two or more flows (121, 122) is in a second set of flows managed by a second control plane entity (110);
wherein the second control plane entity (110) is in at least one of a second network or a second network region (111), or is in a second group of control plane entities of the network; and
establishing (1002) a multi-user QoS policy (103) that defines first information to be used for the management of the two or more flows (121, 122) of the multi-user application (120), which are related to the multi-user group ID;
wherein the multi-user QoS policy (103) is associated with at least one of the multi-user group ID or a multi-user policy ID.
